(19) United States
(12) Patent Application Publication
(10) Pub. No.: US 2025/0371319 A1
(43) Pub. Date: Dec. 4, 2025

(54) METHOD AND SYSTEM FOR IMPLEMENTING TEMPORAL CONVOLUTION IN SPATIOTEMPORAL NEURAL NETWORKS

(71) Applicant: BrainChip, Inc., Laguna Hills, CA (US)

(72) Inventors: Olivier Jean-Marie Dominique COENEN, Laguna Hills, CA (US); Yan Ru PEI, Laguna Hills, CA (US)

(21) Appl. No.: 18/875,149

(22) PCT Filed: Jun. 22, 2023
(86) PCT No.: PCT/US2023/025999

§ 371 Date: Dec. 15, 2024

Related U.S. Application Data
(60) Provisional application No. 63/354,542, filed on Jun. 22, 2022.

(51) Int. Cl. G06N 3/0464; G06N 3/048; G06N 3/049

(52) U.S. Cl. CPC G06N 3/0464; G06N 3/048; G06N 3/049

(57) ABSTRACT

Disclosed is a neural network system generally relates to the field of neural networks (NNs). In particular, the present disclosure relates to event-based convolutional neural networks (NNs) that are trained to process spatial and temporal data using kernels represented by polynomial expansion. The event-based convolutional neural networks (NNs) are spatiotemporal neural networks. According to an embodiment, an explicit temporal convolution capability is added through Temporal Event-based Neural Networks (TENN) models. or TENNs in the spatiotemporal neural networks. The TENNs includes a plurality of temporal and spatial convolution layers that combine spatial and temporal features of data for low-level and high-level features. The TENNs as disclosed herein are configured to perform in a buffer mode and recurrent mode that effectively learns both spatial and temporal correlations from the input data.

### TECHNICAL FIELD

The present disclosure generally relates to the field of neural networks (NNs). In particular, the present disclosure relates to convolutional neural networks (NNs) that are trained to process spatial and temporal data using kernels represented by polynomial expansion.

### BACKGROUND

Neural networks (NNs) are the basis of artificial intelligence (AI) technology. In general, Artificial Neural Network (ANN), Convolutional Neural Network (CNN), and Recurrent Neural Network (RNN) are some of the common types of NNs.

In general, ANNs were initially developed to replicate the behavior of neurons which communicate with each other via electrical signals known as “spikes”. The information conveyed by the neurons was initially believed to be mainly encoded in the rate at which the neurons emit these spikes. Initially, nonlinearities in ANNs, such as sigmoid functions, were inspired by the saturating behavior of neurons. Neurons' firing activity reaches saturation as the neurons approach their maximum firing rate, and nonlinear functions, such as, sigmoid functions were used to replicate this behavior in ANNs. These nonlinear functions became activation functions and allowed ANNs to model complex nonlinear relationships between neuron inputs and outputs.

Further, the traditional ANNs require a large number of training data and computational resources to train the network effectively. ANNs were augmented with the biological observations that individual neurons in the visual cortex respond to stimuli within a spatially small area of the visual field (their receptive field). Neurons responding to the same visual features cover the entire visual field with their overlapping receptive fields. Together with the fact that object recognition is translation invariant, this gave rise to convolutional neural networks (CNNs). An object is recognized regardless of its position in the visual field, or its location in an image. The biological and computational principles of brain processing contributed to the development of CNNs for image recognition tasks.

Currently, most of the accessible data is available in spatiotemporal formats. To use the spatiotemporal forms of data effectively in machine learning applications, it is essential to design a lightweight network that can efficiently learn spatial and temporal features and correlations from data. At present, the convolutional neural network (CNN) is considered the prevailing standard for spatial networks, while the recurrent neural network (RNN) equipped with nonlinear gating mechanisms, such as long short-term memory (LSTM) and gated recurrent unit (GRU), is being preferred for temporal networks.

The CNNs are capable of learning crucial spatial correlations or features in spatial data, such as images or video frames, and gradually abstracting the learned spatial correlations or features into more complex features as the spatial data is processed layer by layer. These CNNs have become the predominant choice for image classification and related tasks over the past decade. This is primarily due to the efficiency in extracting spatial correlations from static input images and mapping them into their appropriate classifications with the fundamental engines of deep learning like gradient descent and backpropagation paring up together. This results in state-of-the-art accuracy for the CNNs. However, many modern Machine Learning (ML) workflows increasingly utilize data that come in spatiotemporal forms, such as natural language processing (NLP) and object detection from video streams. The CNN models used for image classification lack the power to effectively use temporal data present in these application inputs. Importantly, CNNs fail to provide flexibility to encode and process temporal data efficiently. Thus, there is a need to provide flexibility to artificial neurons to encode and process temporal data efficiently.

Recently different methods to incorporate temporal or sequential data, including temporal convolution and internal state approaches have been explored. When temporal processing is a requirement, for example in NLP or sequence prediction problems, the RNNs such as long short-term memory (LSTM) and gated recurrent memory (GRU) models are utilized. Further, according to another conventional method, a 2D spatial convolution combined with state-based RNNs such as LSTMs or GRUs to process temporal information components using models such as ConvLS™ have been used. However, each of these conventional approaches comes with significant drawbacks. For example, while combining 2D spatial convolutions with 1D temporal convolutions requires large amount of parameters due to temporal dimension and is thus not appropriate for efficient low-power inference.

One of the main challenges with the RNNs is the involvement of excessive nonlinear operations at each time step, that leads to two significant drawbacks. Firstly, these nonlinearities force the network to be sequential in time i.e., making the RNNs difficult for efficiently leveraging parallel processing during training. Secondly, since the applied nonlinearities are ad-hoc in nature and lack a theoretical guarantee of stability, it is challenging to train the RNNs or perform inference over long sequences of time series data. These limitations also apply to models, for example, ConvLS™ models as discussed in the above paragraphs, that combine 2D spatial convolution with RNNs to process the sequential and temporal data.

In addition, for each of the above discussed NN models including ANN, CNN, and RNN, the computation process is very often performed in the cloud. However, in order to have a better user experience, privacy, and for various commercial reasons, an implementation of the computation process has started moving from the cloud to edge devices. Various applications like video surveillance, self-driving video, medical vital signs, speech/audio related data are implemented in the edge devices. Further, with the increasing complexity of the NN models, there is a corresponding increase in the computational requirements required to execute highly complex NN Models. Thus, a huge computational processing and a large memory are required for executing highly complex NN Models like CNNs and RNNs in the edge devices. Further, the edge devices are often required to focus on receiving a continuous stream of the same data from a particular application, as discussed above. This necessitates a large memory buffer (time window) of past inputs to perform temporal convolutions at every time step. However, maintaining such a large memory buffer can be very expensive and power-consuming.

Thus, there lies a need for a method and system to reduce the complexity, size, and computational requirements of the above-discussed NN models while still meeting desired accuracy expectations, in order to facilitate the transition of the computation process for the AI system from the cloud to the edge devices.

### SUMMARY

This summary is provided to introduce a selection of concepts in a simplified form that is further described below in the Detailed Description section. This summary is not intended to identify or exclude key features or essential features of the claimed subject matter, nor is it intended to be used as an aid in determining the scope of the claimed subject matter.

According to an embodiment of the present disclosure, disclosed herein is a neural network system that includes an input interface, a memory including a plurality of temporal and spatial layers, and a processor. The input interface is configured to receive sequential data that includes temporal data sequences. The memory is configured to store a plurality of group of first temporal kernel values, a first plurality of First-In-FirstOut (FIFO) buffers corresponding to a current temporal layer. The memory further implements a neural network that includes a first plurality of neurons for the current temporal layer, a corresponding group among the plurality of groups of the first temporal kernel values is associated with each connection of a corresponding neuron of the first plurality of neurons. The processor is configured to allocate the first plurality of FIFO buffers to a first group of neurons among the first plurality of neurons. The processor is then configured to receive a first temporal sequence of the corresponding temporal data sequences into the first plurality of FIFO buffers allocated to the first group of neurons from corresponding temporal data sequences over a first time window. Thereafter, the processor is configured to perform, for each connection of a corresponding neuron of the first group of neurons, a first dot product of the first temporal sequence of the corresponding temporal data sequences within a corresponding FIFO buffer of first plurality of FIFO buffers with a corresponding temporal kernel value among the corresponding group of the first temporal kernel values. The corresponding temporal kernel values are associated with a corresponding connection of the corresponding neuron of the first group of neurons. The processor is then further configured to determine a corresponding potential value for the corresponding neurons of the first group of neurons based on the performed first dot product and then generates a first output response based on the determined corresponding potential values.

According to another embodiment of the present disclosure, disclosed herein is a method performed by a neural network system that includes an input interface, a memory including a plurality of temporal and spatial layers, and a processor. The method includes receiving at the input interface sequential data that includes temporal data sequences. The memory comprises a plurality of groups of first temporal kernel values, a first plurality of FIFO buffers corresponding to a current temporal layer. The memory further comprises a neural network that includes a first plurality of neurons for the current temporal layer, a corresponding group among the plurality of groups of the first temporal kernel values is associated with each connection of a corresponding neuron of the first plurality of neurons. The method includes allocating the first plurality of FIFO buffers to a first group of neurons among the first plurality of neurons. The method further includes receiving a first temporal sequence of the corresponding temporal data sequences into the first plurality of FIFO buffers allocated to the first group of neurons from corresponding temporal data sequences over a first time window. Thereafter, the method includes performing, for each connection of a corresponding neuron of the first group of neurons, a first dot product of the first temporal sequence of the corresponding temporal data sequences within a corresponding FIFO buffer of first plurality of FIFO buffers with a corresponding temporal kernel value among the corresponding group of the first temporal kernel values. The corresponding temporal kernel values are associated with a corresponding connection of the corresponding neuron of the first group of neurons. The method further includes determining a corresponding potential value for the corresponding neurons of the first group of neurons based on the performed first dot product and then generates a first output response based on the determined corresponding potential values.

In one or more embodiments, for determining the corresponding potential value for the corresponding neuron of the first group of neurons among the first plurality of neurons, the method at first includes applying one or more nonlinear activation functions on the corresponding results of the first dot product. Thereafter, the method further includes determining, based on a result of the application of the one or more nonlinear activation functions on the corresponding results of the dot product, the corresponding potential value for the corresponding neurons of the group of neurons among the first plurality of neurons.

According to another embodiment of the present disclosure, also disclosed herein is a neural network system that includes an input interface, a memory, and at least one processor. The input interface is configured to receive sequential data that includes temporal data sequences. The memory is configured to implement a neural network and store a plurality of temporal kernel coefficients, a reference matrix to update a memory vector. The neural network is configured to perform a temporal convolution using one or more temporal layers. A corresponding temporal layer of the one or more temporal layers includes of a plurality of neurons. For a corresponding temporal layer of the one or more temporal layers, the at least one processor is configured to receive a first temporal data sequence of the temporal data sequences at a first time instance, and thereafter transform, for the first temporal data sequence, the memory vector based on a matrix multiplication of the reference matrix with the memory vector. For the corresponding temporal layer of the one or more temporal layers, the at least one processor is further configured to generate an updated memory vector based on the transformed memory vector and a projected temporal input that is generated based on the first temporal data sequence. Thereafter, for the corresponding temporal layer of the one or more temporal layers, the at least one processor is further configured to perform, for each connection associated with a corresponding neuron of a group of neurons among the plurality of neurons, a dot product of the generated memory vector with the plurality of temporal kernel coefficients. Furthermore, for the corresponding temporal layer of the one or more temporal layers, the at least one processor is further configured to determine a corresponding potential value for the corresponding neurons based on the performed dot product, and thereafter generate an output response based on the determined corresponding potential values.

According to another embodiment of the present disclosure, also disclosed herein is a neural network system that includes an input interface, a memory, and at least one processor. The input interface is configured to receive sequential data that includes temporal data sequences. The memory is configured to implement a neural network and store one or more temporal kernel coefficients for a temporal layer, and a projection vector for each of the temporal data sequences, a reference matrix to update a memory vector. The neural network includes a spatial layer and a temporal layer, and the temporal layer includes a first plurality of neurons. For the temporal layer, the at least one processor is configured to receive a first data sequence of the temporal data sequences at a first time instance, and thereafter project the projection vector onto the received first data sequence. For the temporal layer, the at least one processor is further configured to determine a projected temporal input based on the projection of the first reference matrix onto the first input data sequence, and thereafter transform, the memory vector based on a matrix multiplication of the reference matrix with the memory vector. For the temporal layer, the at least one processor is further configured to generate an updated memory vector based on an addition of the transformed memory vector with the determined projected temporal input. Thereafter, for the temporal layer, the at least one processor is further configured to perform, for a corresponding neuron of a group of neurons among the first plurality of neurons, a dot product of the generated memory vector with the one or more temporal kernel coefficients. Furthermore, for the temporal layer, the at least one processor is further configured to determine a corresponding potential value for the corresponding neurons of the group of neurons based on the performed dot product, and thereafter generate an output response based on the determined corresponding potential values.

According to yet another embodiment of the present disclosure, also disclosed herein is a method performed by a neural network system that includes an input interface, a memory, and at least one processor. The method includes receiving, at the input interface, sequential data that includes temporal data sequences. The memory comprises a plurality of temporal kernel coefficients, a reference matrix to update a memory vector, and a neural network implemented therein. The neural network is configured to perform a temporal convolution using one or more temporal layers. A corresponding temporal layer of the one or more temporal layers includes of a plurality of neurons. For a corresponding temporal layer of the one or more temporal layers, the method further includes receiving, by the at least one processor, a first temporal data sequence of the temporal data sequences at a first time instance, and then transforming, by the at least one processor for the first temporal data sequence, the memory vector based on a matrix multiplication of the reference matrix with the memory vector. For the corresponding temporal layer of the one or more temporal layers, the method further includes generating, by the at least one processor, an updated memory vector based on the transformed memory vector and a projected temporal input that is generated based on the first temporal data sequence. Thereafter, or the corresponding temporal layer of the one or more temporal layers, the method further includes performing, by the at least one processor for each connection associated with a corresponding neuron of a group of neurons among the plurality of neurons, a dot product of the generated memory vector with the plurality of temporal kernel coefficients. Furthermore, for the corresponding temporal layer of the one or more temporal layers, the method includes determining, by the at least one processor, a corresponding potential value for the corresponding neurons based on the performed dot product, and then generating, by the at least one processor, an output response based on the determined corresponding potential values.

In one or more embodiments, for determining the corresponding potential value for the corresponding neurons, the method includes applying one or more activation functions on the corresponding result of the dot products. Thereafter, the method includes determining the corresponding potential value for the corresponding neurons based on a result of the application of the one or more activation functions on the corresponding result of the dot products.

### BRIEF DESCRIPTION OF DRAWINGS

Non-limiting and non-exhaustive embodiments of the invention are described with reference to the following figures, wherein reference numerals refer to like parts throughout the various views unless otherwise specified.

FIG. 1 illustrates an example system diagram of an apparatus configured to implement a spatiotemporal neural network, in accordance with an embodiment of the disclosure.

FIG. 2 illustrates another example system diagram of an apparatus configured to implement the spatiotemporal neural network, in accordance with an embodiment of the disclosure.

FIG. 3 illustrates a detailed system architecture of the apparatus configured to implement the spatiotemporal neural network, in accordance with an embodiment of the disclosure.

FIG. 4 illustrates an example representation of the spatiotemporal neural network including convolution neural layers and a plurality of neurons therein along with allocated corresponding FIFO buffers and corresponding kernel values, in accordance with an embodiment of the disclosure.

FIG. 5 illustrates the operations to determine the output response of a single neuron for a single channel based on a temporal convolution using the FIFO buffer in a buffer mode operation, in accordance with embodiment of the present disclosure.

FIG. 6 illustrates an operation for determining the output response of a neuron in case a temporal convolution layer is followed by a spatial convolution layer in buffer mode operation, according to an embodiment of the present disclosure.

FIG. 7 illustrates the spatiotemporal operations of the neural network whereby a temporal convolution operation is performed at each of the plurality of temporal convolution layers followed by a spatial convolution operation performed at each of the plurality of the spatial convolution layers, itself followed by another temporal convolution operation, and another spatial convolution, and so on, for a plurality of alternating temporal and spatial convolution layers of the neural network 400 in the buffer mode, according to an embodiment of the present disclosure.

FIG. 8 illustrates a detailed operation of shifting of the data in a FIFO buffer in temporal convolution layers in a buffer mode operation, according to an embodiment of the present disclosure.

FIG. 9 illustrates an example scenario depicting an application of the buffer mode to a multi-channel operation of the spatiotemporal neural network 400 of FIG. 4, in accordance with an embodiment of the present disclosure.

FIG. 10 illustrates an example method 850 for performing multiple temporal convolutions in parallel by one or more temporal convolution layers of the spatiotemporal neural network 400 in the buffer mode in the multi-channel scenario, in accordance with an embodiment of the disclosure.

FIG. 11 illustrates an example method 900 for performing a temporal convolution scaled by multiple values by one or more temporal convolution layers of the spatiotemporal neural network 400400 in the buffer mode in the multi-channel scenario, in accordance with an embodiment of the disclosure.

FIG. 12 is a flow chart of a method 1050 performed by a processing system 300 including a neural processor 320 for performing temporal convolutions followed by spatial convolutions in the buffer mode using one or more convolution layers of the spatiotemporal neural network 400, in accordance with an embodiment of the disclosure.

FIG. 13 illustrates an example representation of the spatiotemporal neural network including spatial and temporal convolution neural layers and the plurality of neurons along with the working of the spatiotemporal neural network in a recurrent mode, in accordance with an embodiment of the disclosure.

FIG. 14 illustrates an example representation of a uniformly sampled temporal kernel which is represented as a sum of a set of kernel coefficients multiplied by polynomials forming an orthogonal basis, in accordance with an embodiment of the disclosure.

FIG. 15 illustrates an example scenario depicting a method of performing temporal convolution at a corresponding temporal convolution layer of the spatiotemporal neural network 500 in the recurrent mode, in accordance with an embodiment of the disclosure.

FIG. 16 illustrates an example scenario depicting an application of the recurrent mode to a multi-channel operation of the spatiotemporal neural network 500 of FIG. 13, in accordance with an embodiment of the present disclosure.

FIG. 17 illustrates an example method 1150 for performing recurrence and updating the internal states along basis functions of the one or more temporal convolution layers in the recurrent mode in a multi-channel scenario, in accordance with an embodiment of the disclosure.

FIG. 18 illustrates an example method 1160 for performing a non-separable feedforward operation in the multi-channel scenario, in accordance with an embodiment of the disclosure.

FIG. 19 illustrates an example method 1200 for performing a separable feedforward operation in the multi-channel scenario, in accordance with an embodiment of the disclosure.

FIG. 20 is a flow chart of a method 1250 performed by the neural processor for performing recurrent operations followed by spatial convolutions in the recurrent mode using one or more convolution layers of the spatiotemporal neural network 500, in accordance with an embodiment of the disclosure.

FIG. 21 illustrates another exemplary scenario depicting methods for performing full feedforward projections and separable feedforward projections in the recurrent mode in the multi-channel scenario, in accordance with an embodiment of the disclosure.

FIG. 22 illustrates an exemplary scenario depicting an entire network built from a stack of STBlocks consisting of buffered temporal layers, interfacing with theDVS128 data, in accordance with one or more embodiments of the disclosure.

The features and advantages of the present disclosure will become more apparent from the detailed description set forth below when taken in conjunction with the drawings, in which similar reference numbers identify corresponding elements throughout. In the drawings, similar reference numbers generally indicate identical, functionally similar, and/or structurally similar elements. Further, the drawings may show only those specific details that are pertinent to understanding the embodiments of the invention so as not to obscure the drawings with details that will be readily apparent to those of ordinary skill in the art having the benefit of the description herein.

### DETAILED DESCRIPTION

Detailed descriptions of various embodiments are presented herein, along with accompanying drawings that form an essential component of this disclosure. Said drawings serve to illustrate specific embodiments, thereby providing a more comprehensive understanding of the subject matter. However, the concepts of the present disclosure may be implemented in many different forms and should not be construed as limited to the embodiments set forth herein; rather, these embodiments are provided as part of a thorough and complete disclosure, to fully convey the scope of the concepts, techniques, and implementations of the present disclosure to those skilled in the art. Embodiments may be practiced as methods, systems, or devices. Accordingly, embodiments may take the form of a hardware implementation, an entire software implementation, or an implementation combining software and hardware aspects. The following detailed description is, therefore, not to be taken in a limiting sense.

Reference in the specification to “one embodiment”, “an embodiment”, “another embodiment”, or “some embodiment” means that a particular feature, structure, or characteristic described in connection with the embodiments is included in at least one example implementation or technique in accordance with the present disclosure. The appearances of the phrase “in an embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments of the present disclosure may be implemented in hardware, firmware, software, or any combination thereof. Embodiments of the present disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others. Further, firmware, software, routines, and instructions may be described herein as performing certain actions. However, it should be appreciated that such descriptions are merely for convenience and that such actions result from computing devices, processors, controllers, or other devices executing the firmware, software, routines, instructions, etc.

Before describing such embodiments in more detail, however, it is instructive to present an example environment in which embodiments of the present disclosure may be implemented.

The present disclosure discloses a neural network (NNs), particularly related to convolutional neural networks (NNs) that are trained to process spatial and temporal data using kernels represented by a set of basis functions, including a polynomial expansion. The convolutional neural networks (NNs) are spatiotemporal neural networks. According to an embodiment, an explicit temporal convolution capability is added through Temporal Event-based Neural Networks (TENN) models, or TENNs in the spatiotemporal neural networks. The TENNs includes a plurality of temporal and spatial convolution layers that combine spatial and temporal features of data for low-level and high-level features. The TENNs as disclosed herein may effectively learn both spatial and temporal correlations from the input data.

According to an embodiment, the spatiotemporal networks may be configured to perform the temporal convolution operations either in a buffered temporal convolution mode or a recurrent temporal convolution mode, and may be alternatively referred to as a “buffer mode” or a “recurrent mode”, respectively.

According to an embodiment, the spatiotemporal network may be configured with a plurality of spatiotemporal convolution layers. Each of the spatiotemporal layers may be further split into plurality of temporal and spatial convolution layers. The kernels for the temporal and spatial convolution layers are represented as a sum over a set of basis functions, such as orthogonal polynomials, where the coefficients of the basis functions are trainable parameters of the network. This basis function representation compresses the number of parameters of the spatiotemporal network, which makes the training of the spatiotemporal network stable and resistant to overfitting.

Embodiments of the present invention will be described below in detail with reference to the accompanying drawings.

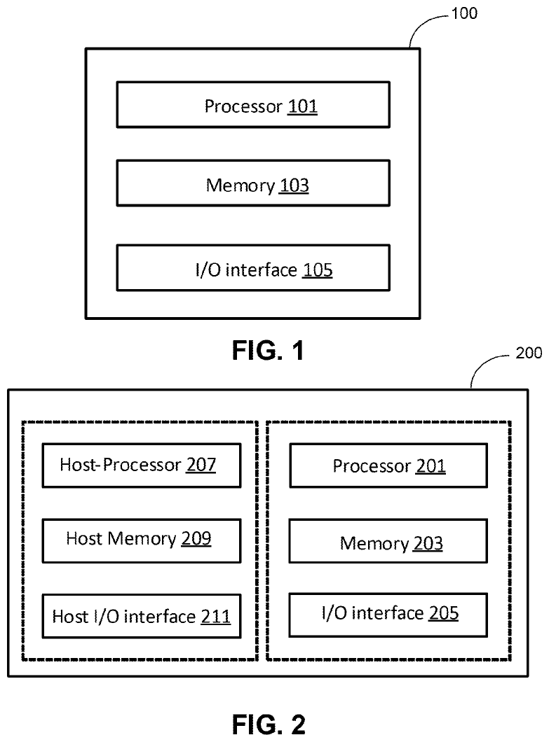

FIG. 1 illustrates an example system diagram of an apparatus configured to implement a spatiotemporal neural network, in accordance with an embodiment of the disclosure. FIG. 1 depicts a system 100 to implement a spatiotemporal neural network. The system 100 includes a processor 101, a memory 103, and an I/O interface 105.

The processor 101 can be a single processing unit or several units, all of which could include multiple computing units. The processor 101 is configured to fetch and execute computer-readable instructions and data stored in the memory 103. The processor 101 may receive computer-readable program instructions from the memory 103 and execute these instructions, thereby performing one or more processes defined by the system 100. The processor 101 may include any processing hardware, software, or combination of hardware and software utilized by a computing device that carries out the computer-readable program instructions by performing arithmetical, logical, and/or input/output operations. Examples of the processor 101 include but are not limited to an arithmetic logic unit, which performs arithmetic and logical operations, a control unit, which extracts, decodes, and executes instructions from a memory, and an array unit, which utilizes multiple parallel computing elements.

The memory 103 may include a tangible device that retains and stores computer-readable program instructions, as provided by the system 100, for use by the processor 101. The memory 103 can include computer system readable media in the form of volatile memory, such as random-access memory, cache memory, and/or a storage system. The memory 103 may be, for example, dynamic random-access memory (DRAM), a phase change memory (PCM), or a combination of the DRAM and PCM. The memory 103 may also include any non-transitory computer-readable medium known in the art including, for example, volatile memory, such as static random-access memory (SRAM), and/or non-volatile memory, such as read-only memory (ROM), erasable programmable ROM, flash memories, etc.

The I/O interface 105 includes a plurality of communication interfaces comprising at least one of a local bus interface, a Universal Serial Bus (USB) interface, an Ethernet interface, a Controller Area Network (CAN) bus interface, a serial interface using a Universal Asynchronous Receiver-Transmitter (UART), a Peripheral Component Interconnect Express (PCIe) interface, or a Joint Test Action Group (JTAG) interface. Each of these buses can be a network on a chip (NoC) bus. According to some embodiments, the I/O interface may further include sensor interfaces that can include one or more interfaces for pixel data, audio data, analog data, and digital data. Sensor interfaces may also include an AER interface for DVS pixel data.

FIG. 2 illustrates another example system diagram of an apparatus configured to implement the spatiotemporal neural network, in accordance with an embodiment of the disclosure. FIG. 2 depicts a system 200 to implement the spatiotemporal neural network. The system 200 includes a processor 201, a memory 203, an I/O interface 205, Host-Processor 207, a Host memory 209, and a Host I/O interface 211. The functionalities, operations, and examples associated with the processor 201, memory 203, and I/O interface 205 of the system 200 are similar to that of the processor 101, memory 103, and I/O interface 105 of the system 100 of FIG. 1. Therefore, a description of the same is omitted herein for the sake of brevity and ease of explanation of the invention.

The host-processor 207 is a general-purpose processor, such as, for example, a state machine, a high-throughput MIC processor, a network or communication processor, a compression engine, a graphics processor, a general-purpose computing graphics processing unit (GPGPU), an embedded processor, or the like. The processor 201 may be a special purpose processor that communicates/receives instructions from the host processor 207. The processor 201 may recognize the host-processor instructions as being of a type that should be executed by the host-processor 207. Accordingly, the processor 201 may issue the host-processor instructions (or control signals representing host-processor instructions) on a host-processor bus or other interconnect, to the host-processor 207.

The host memory 209 may include any type or combination of volatile and/or non-volatile memory. Examples of volatile memory include various types of random-access memory (RAM), such as dynamic random access memory (DRAM), synchronous dynamic random-access memory (SDRAM), and static random access memory (SRAM), among other examples. Examples of non-volatile memory include disk-based storage mediums (e.g., magnetic and/or optical storage mediums), solid-state storage (e.g., any form of persistent flash memory, including planar or three dimensional (3D) NAND flash memory or NOR flash memory), a 3D Crosspoint memory, electrically erasable programmable read-only memory (EEPROM), and/or other types of non-volatile random-access memories (RAM), among other examples. Host memory 209 may be used, for example, to store information for the host-processor 207 during the execution of instructions and/or data.

The host I/O interface 211 corresponds to a communication interface that may be any one of a variety of communication interfaces, but are limited to, such as a wireless communication interface, a serial interface, a small computer system (SCSI) interface, an Integrated Drive Electronics (IDE) interface, etc. Each communication interface may include a hardware present in each host and a peripheral I/O that operates in accordance with a communication protocol (which may be implemented, for example, by computer-readable program instructions stored in the host memory 209) suitable for this type of communication interface, as will be apparent to anyone skilled in the art.

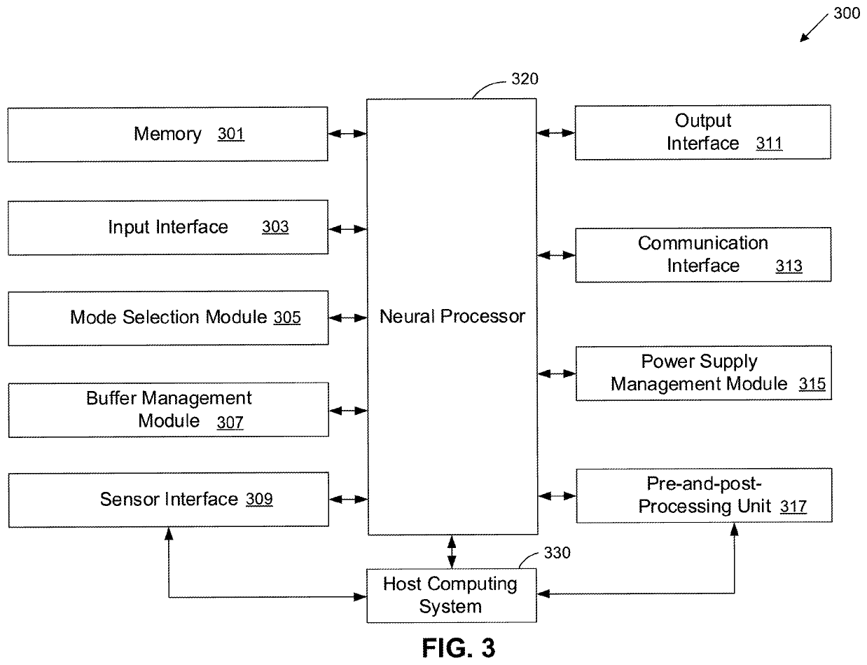

FIG. 3 illustrates a detailed system architecture of the apparatus configured to implement the spatiotemporal neural network, in accordance with an embodiment of the disclosure. FIG. 3 depicts a system 300 to implement the spatiotemporal neural network. The system 300 includes a memory 301, an input interface 303, a mode selection module 305, a buffer management module 307, a sensor interface 309, an output interface 311, a communication interface 313, power supply management module 315, pre-and-post-processing unit 317, a neural processor 320, and a host computing system 330. The host computing system 330 may include the host-processor 207, host memory 209, and host I/O interface 211. The functionalities, operations, and examples associated with the components of the host computing system 330 are the same as that of the host-processor 207, host memory 209, and host I/O interface 211 of the system 200. Therefore, a description of the same is omitted herein for the sake of brevity and ease of explanation of the invention.

The neural processor 320 may correspond to a neural processing unit (NPU). The (NPU) is a specialized circuit that implements all the necessary control and arithmetic logic necessary to execute machine learning algorithms, typically by operating on models such as artificial neural networks (ANNs) and spiking neural networks (SNNs). NPUs sometimes go by similar names such as a tensor processing unit (TPU), neural network processor (NNP), and intelligence processing unit (IPU) as well as vision processing unit (VPU) and graph processing unit (GPU). According to some embodiments, the NPUs may be a part of a large SoC, a plurality of NPUs may be instantiated on a single chip, or they may be a part of a dedicated neural-network accelerator. The neural processor 320 may also correspond to a fully connected neural processor in which processing cores are connected to inputs by the fully connected topology. Further, in accordance with an embodiment of the disclosure, the processor 101, 201, and the neural processor 320 may be an integrated chip, for example, a neuromorphic chip.

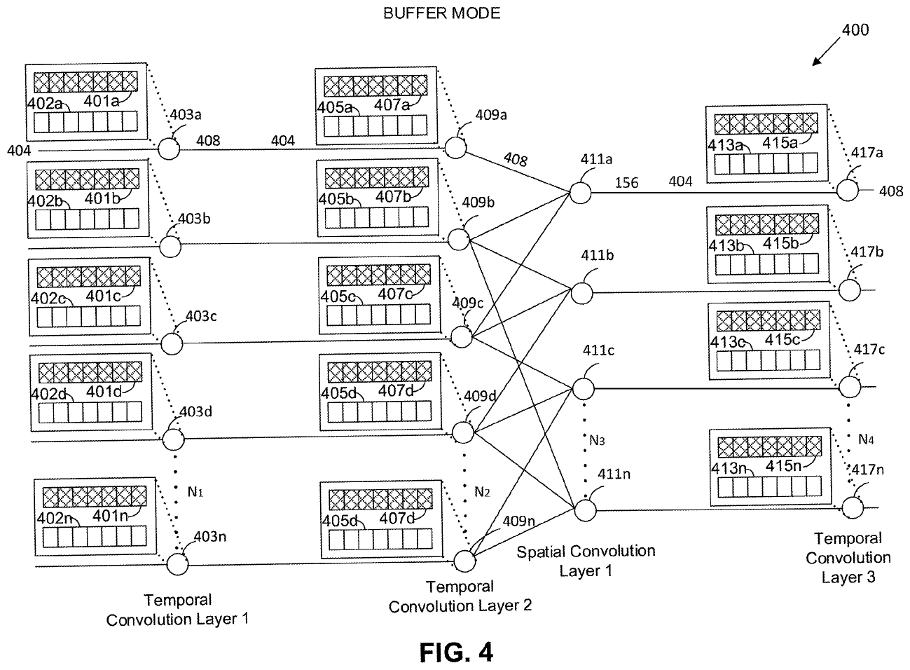

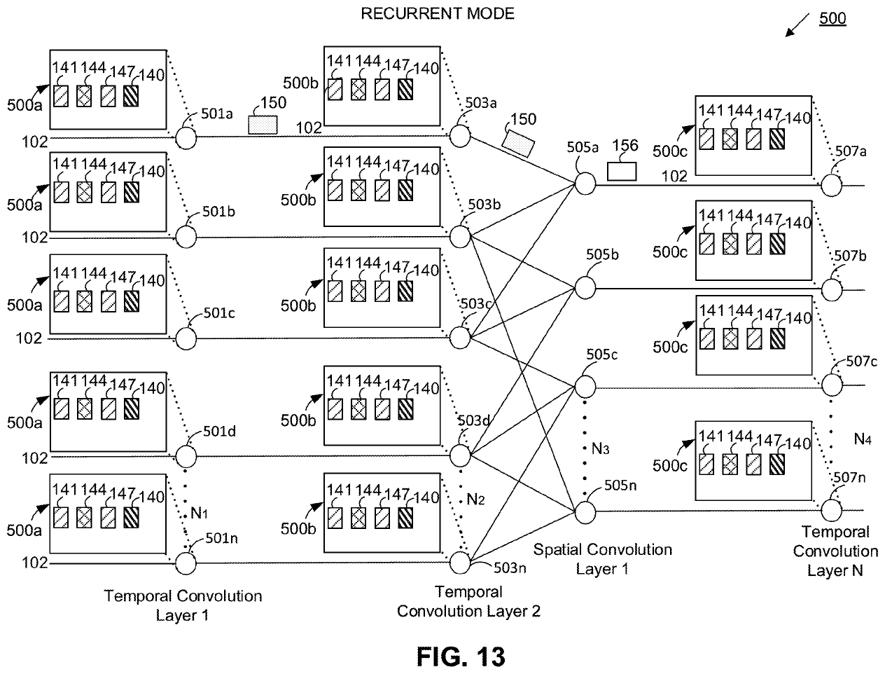

Also, examples of the memory 301 coupled to the neural processor 320 are the same as that of the memory examples described above with reference to the memory of FIG. 1 and FIG. 2. The memory 301 may be configured to implement the spatiotemporal neural network that includes a plurality of neurons at each of the temporal and spatial convolution layer (as described in forthcoming paragraph with reference to FIGS. 4 and 13 of the drawings). According to an embodiment, in the buffer mode, the memory 301 may be configured to store a plurality of group of temporal kernel values and a plurality of First-In, First-Out (FIFO) buffers corresponding to each of the temporal convolution layers of the spatiotemporal neural network. In addition, in the buffer mode, the memory 301 may be further configured to store a plurality of groups of spatial kernel values corresponding to each of the spatial convolution layers of the spatiotemporal neural network. According to an embodiment, each of the FIFO buffers may share the same temporal kernel values for each neuron of a corresponding temporal convolution layer. The temporal kernel values are associated with each connection of a corresponding neuron among the plurality of neurons of the respective temporal convolution layers. A detailed explanation of implementation of the spatiotemporal neural network within the memory 301 in the buffer mode is described below in detail with reference to FIG. 4 of the drawings. Further, a detailed description of the implementation of the spatiotemporal neural network within the memory 301 in the recurrent mode will be described below in forthcoming paragraphs with reference to FIG. 13 of the drawings.

According to an embodiment, each of the neurons among the plurality of the neurons of one temporal convolution layer is connected with one or more neurons of the next convolution layer using neural connections each having specific connection parameters. A detailed explanation of the neural connections of the neurons and the associated connection parameters is described below in the forthcoming paragraphs with reference to FIG. 4 of the drawings.

The input interface 303 is configured to receive sequential data as input. According to an embodiment, the sequential data may include one or more temporal data sequences. According to a non-limiting example, the sequential data may include single or multi-channel tensor data received from sensors or electronic devices and the like.

The output interface 311 may include any number and/or combination of currently available and/or future-developed electronic components, semiconductor devices, and/or logic elements capable of receiving input data from one or more input devices and/or communicating output data to one or more output devices. According to some embodiments, a user of the system 300 may provide a neural network model and/or input data using one or more input devices wirelessly coupled and/or tethered to the output interface 311. The output interface 311 may also include a display interface, an audio interface, an actuator sensor interface, and the like.

The sensor interface 309 may correspond to a plurality of sensors including, but not limited to, an imaging sensor, a microphone, a motion sensor, a gyro sensor, a magnetometer, a temperature sensor, a humidity sensor, an accelerometer sensor, a spectrometric sensor, etc. The sensor interface 309 may also include at least one gyroscope sensor, a location sensor, a gesture recognition sensor, and/or a sensor for the detection of physiological parameters associated with the user of the system 300.

The communication interface 313 may comprise a single, local network, a large network, or a plurality of small or large networks interconnected together. The communication interface 313 may also comprise any type or number of local area networks (LANs) broadband networks, wide area networks (WANs), and a Long-Range Wide Area Network, etc. Further, the communication interface 313 may incorporate one or more LANs, and wireless portions and may incorporate one or more various protocols and architectures such as TCP/IP, Ethernet, etc. The communication interface 313 may also include a network interface to communicate via offline and online wireless communication with networks, such as the Internet, an Intranet, and/or a wireless network, such as a cellular telephone network, a wireless local area network (WLAN), personal area network, and/or a metropolitan area network (MAN). Wireless communication may use any of a plurality of communication standards, protocols, and technologies, such as LTE, 5G, beyond 5G networks, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VOIP), Wi-MAX, Internet-of-Things (IoT) technology, Machine-Type-Communication (MTC) technology, a protocol for email, instant messaging, and/or Short Message Service (SMS).

The pre-and-post-processing unit 317 may be configured to perform several tasks, such as but not limited to reshaping/resizing of data, conversion of data type, formatting, quantizing, image classification, object detection, etc. whilst maintaining the same spatiotemporal neural network architecture.

The mode selection module 305 may be configured to select one of the buffer mode or the recurrent mode to perform temporal convolution operations at one or more temporal convolution layers of the spatiotemporal neural network implemented in the memory 301. A detailed explanation of the temporal convolution operations in the buffer mode is described below in the forthcoming paragraphs with reference to FIGS. 4 through 12 of the drawings. Further, a detailed explanation of the temporal convolution operations in the recurrent mode is described below in the forthcoming paragraphs with reference to FIGS. 13 through 21 of the drawings.

The buffer management module 307 may be configured to manage the FIFO buffer that is allocated to a plurality of group of neurons at one or more temporal convolution layers of the spatiotemporal neural network. A detailed explanation of the configuration of spatiotemporal network with respect to the FIFO buffer is described below in the forthcoming paragraphs with reference to FIGS. 4 through 12 of the drawings.

The power supply management module 315 may be configured to supply power to the various modules of the system 300.

According to an embodiment of the disclosure, FIG. 4 illustrates an example representation of the spatiotemporal neural network 400 including convolution neural layers and a plurality of neurons therein along with allocated corresponding FIFO buffers and corresponding kernel values, in accordance with an embodiment of the disclosure. FIG. 4 illustrates a spatiotemporal neural network 400 for performing one or more temporal convolutions followed by spatial convolution in the buffer mode. For the sake of brevity of the present disclosure, a temporal convolution operation using FIFO buffers is described with reference to a single convolution layer, for example, temporal convolution layer 1 of spatiotemporal neural network 400.

According to an embodiment of the present disclosure, the spatiotemporal neural network 400 includes the plurality of temporal convolution layers configured with one or more spatial convolution layers. The sequence of the plurality temporal convolution layers and the spatial convolution layer as shown in FIG. 4 is exemplary and is not intended to limit the scope of the embodiments of the present disclosure. For example, the spatial convolution layer 1 may be arranged before or after any of the temporal convolution layer 1, 2, or N. Similarly, the corresponding temporal convolution layers 1 through N may be arranged in any other alternate sequence without any deviation from the scope of the present disclosure.

The spatiotemporal neural network 400 includes one or more spatial convolution layers including a spatial convolution layer 1, and a plurality of temporal convolution layers, i.e., temporal convolution layers 1 through N. As described herein above, the memory 301 is configured to implement the spatiotemporal neural network 400 and store the plurality of temporal kernel for the corresponding temporal convolution layer of the plurality of convolution layers 1 through N.

In one or more embodiments, the spatiotemporal neural network 400 is configured to perform one or more temporal convolutions using one or more temporal convolution layers of the spatiotemporal neural network 400. A corresponding temporal convolution layer of the spatiotemporal neural network 400 includes of a plurality of neurons. For example, the temporal convolution layer 1 includes a first plurality of neurons 403a through 403n, the temporal convolution layer 2 includes a second plurality of neurons 409a through 409n, and the temporal convolution layer 3 includes a third plurality of neurons 417a through 417n. A number of the neurons at each of the temporal convolution layers may be different. For example, a number of the neurons at the temporal convolution layer 1 may be N1, a number of the neurons at the temporal convolution layer 2 may be N2, and a number of the neurons at the temporal convolution layer 3 may be N4. The spatial convolution layer 1 includes a plurality of neurons 411a through 411n (N3). According to an embodiment, the first plurality of neurons includes a first group of neurons by grouping any number of neurons within the same temporal convolution layer.

In an implementation, the memory 301 is configured to allocate a first plurality of FIFO buffers 401a through 401n to a first group of neurons among the first plurality of neurons 403a through 403n of the temporal convolution layer 1. The memory 301 is further configured store a plurality of group of first temporal kernel values 402a through 402n each corresponding to a respective FIFO buffer among the first plurality of FIFO buffers 401a through 401n. In an implementation, the memory 301 is further configured to allocate a second plurality of FIFO buffers 405a through 405n to a second group of neurons among the second plurality of neurons 409a through 409n of the next temporal layer (e.g., temporal convolution layer 2). The memory 301 is further configured to store a plurality of groups of second temporal kernel values 405a through 405n corresponding to a respective FIFO buffer of the allocated second plurality of FIFO buffers 405a through 405n.

Likewise, the memory 301 is configured to allocate a third plurality of FIFO buffers 415a through 415n to a third group of neurons among the third plurality of neurons 417a through 417n. Accordingly, the memory 301 is configured to store a plurality of group of third temporal kernel values 413a through 413n corresponding to a respective FIFO buffer among the allocated third plurality of FIFO buffers 415a through 415n.

Further, a configuration of the spatiotemporal neural network 400 defines one or more connections between the plurality of neurons of the corresponding temporal convolution layers 1 through N and the spatial convolution layer 1. The neural processor 320 is configured to perform the one or more temporal convolutions and spatial convolutions using neurons of the one or more temporal convolution layers and the spatial convolution layer of the spatiotemporal neural network 400. In particular, the neural processor 320 is configured to perform the one or more temporal convolutions by performing a series of operations on each of the temporal data sequences utilizing the FIFO buffer, and the temporal kernel values. A detailed description of the series of operations for performing the temporal convolution is described below with reference to FIG. 4 through FIG. 9 of the drawings.

According to an embodiment, in the buffer mode, the temporal operation of the spatiotemporal network 400 is causal and valid type convolution. The FIFO buffer is configured to receive the input data and processes it in a sliding window fashion. In an implementation, the input interface 303 is configured to receive, from corresponding temporal data sequences over a first time window, a first temporal sequence 404 (i.e., new input) of the temporal data sequences into the first plurality of FIFO buffers 401a through 401n allocated to the first group of neurons. According to an embodiment, the first plurality of FIFO buffer may be collectively referred to as 401 without any deviation from the scope of the present disclosure. Similarly, the second plurality of FIFO buffer may be collectively referred to as 407 and likewise, the third plurality of FIFO buffer may be collectively referred to as 415. The first plurality of neurons in the temporal convolution layer 1 may be collectively referred to as 403. Similarly, the second plurality of neurons in the temporal convolution layer 2 may be collectively referred to as 409 and likewise the third plurality of neurons in the temporal convolution layer 3 may be collectively referred to as 417. The first temporal kernel values 402a through 402n may be collectively referred to as 402. Similarly, the second temporal kernel values 405a through 405n may be collectively referred to as 405 and likewise the third temporal kernel values 413a through 413n may be collectively referred to as 413.

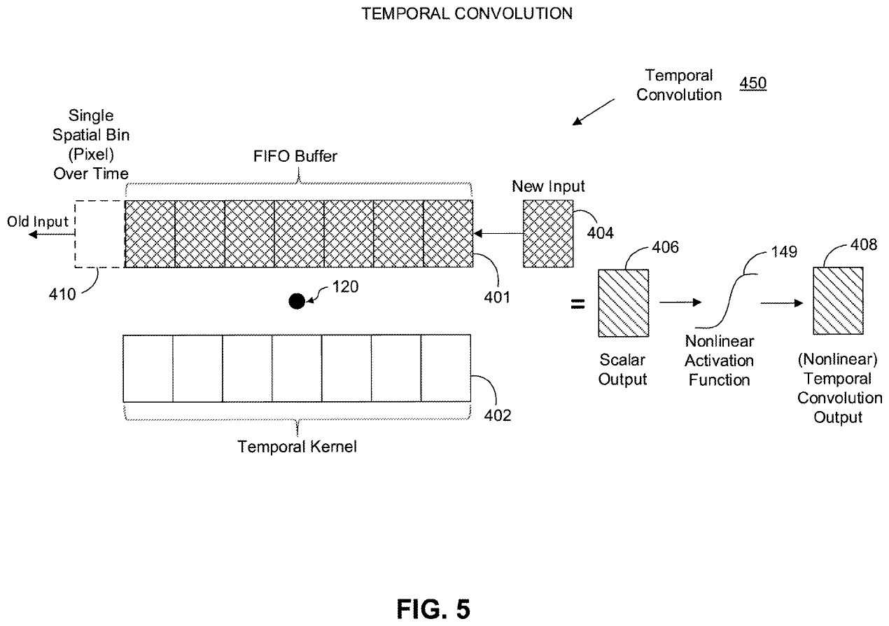

According to an embodiment, each of the temporal data of the temporal data sequence is received and stored in each location of the FIFO buffer 401a over a time period for a particular time stamp (i.e., timebin). In a non-limiting example, the single temporal data represents a single spatial bin, such as a single pixel of an image at an input layer, including the temporal data sequence that is received as a single spatial bin (pixel) over the particular time stamp as depicted in FIG. 5.

The process of performing a temporal convolution with the FIFO buffer is shown in FIG. 5, where the procedure is simplified by considering only single-channel operation.

FIG. 5 illustrates the operations within a temporal convolution layer including a temporal convolution using the FIFO buffer in single neuron for a single channel in a buffer mode operation, in accordance with embodiment of the present disclosure. According to an embodiment, after the reception of the first temporal sequence 404, the neural processor 320 is configured to perform a first dot product 120 of the first temporal sequence 404 with a corresponding temporal kernel 402 among the corresponding temporal kernels in the group of first temporal kernels 402. The temporal data sequences are stored within a corresponding FIFO buffer of the first plurality of FIFO buffers 401. In an implementation the dot product is performed for each connection of a corresponding neuron with a corresponding kernel in the temporal convolution layer. Referring to FIG. 4 the dot product is performed between the temporal data sequences that are present in the FIFO buffer 401a and its corresponding kernel values 402a. In an implementation, the kernel values are associated with a corresponding connection of the corresponding neuron. For example, referring to FIG. 4, the corresponding temporal kernel values 402a are associated with a corresponding connection of the corresponding neuron 403a of the first group of neurons 403.

According to an embodiment, the temporal kernel values are discretized in timebins. The kernel coefficients are used for generating a continuous temporal kernel expressed as an expansion over kernel coefficients multiplying a set of basis functions. This continuous temporal kernel is then discretized in a number of timebins. The number of timebins is used herein to represent the values of the temporal kernels and may match with a size of the FIFO buffer that holds the input, which thus has been discretized using the same size timebins and the same nbr of timebins.

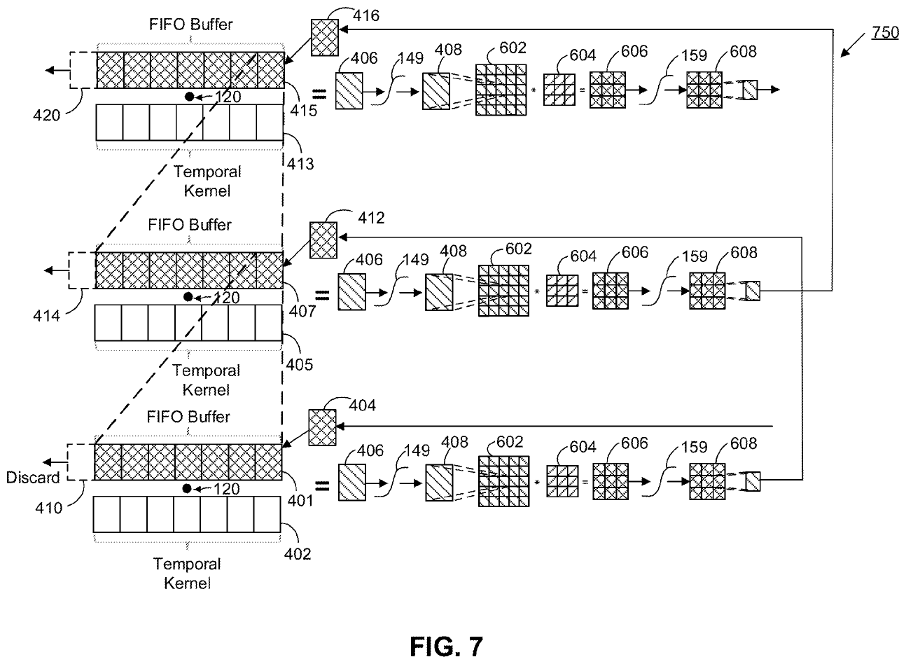

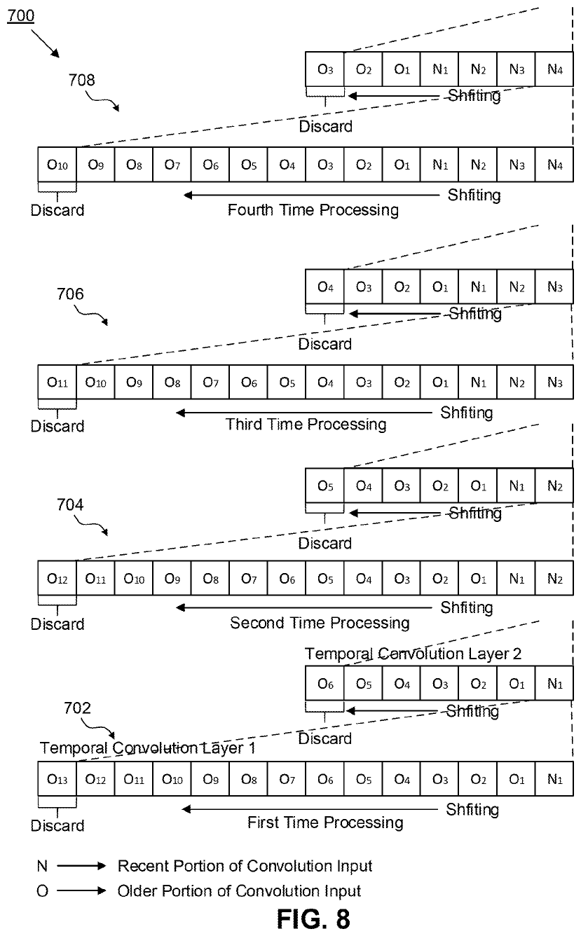

Thus, the temporal kernels are represented as an expansion over basis functions, such as orthogonal polynomials, and the temporal kernels may be obtained from a set of basis function coefficients, the kernel coefficients, that are optimized during training in buffer mode, so that the shapes of the temporal kernels are driven by the data and not limited to some a priori definition. This implies that the temporal operation only looks at past and present inputs. This reduces the latency of the system to a large extent, since at any given layer, processing may begin immediately after the data corresponding to the current time instance is output by the previous layer. In addition, the representation of the temporal kernels as expansion over orthogonal polynomials allows the temporal operation to be easily converted between buffered mode and recurrent mode. The aforesaid advantage may be ascertained from the detailed operation of the buffer mode with reference to FIGS. 7 and 8 in the forthcoming paragraphs.

According to an embodiment, a single dot product is performed between the corresponding temporal kernel 402 in FIG. 5 or 402a in FIG. 4 and the corresponding temporal sequential data in the corresponding FIFO buffer 401 in FIG. 5 or 401 in FIG. 4. In a similar manner, the neural processor 320 is configured to perform the dot product for the complete sequential data inputs to generate a corresponding output response as a result of each of the performed dot products.

After performing the first dot product, the neural processor 320 is configured to determine a corresponding potential value for the corresponding neuron 403a of the first group of neurons 403 based on the performed first dot product 120 (FIGS. 4 & 5). According to an embodiment, the result of the corresponding first dot product 120 is a corresponding scalar output 406. As described herein above, the similar dot product operation is performed for the corresponding neurons 409a through 409n of the second group of neurons 409, and the corresponding neurons 417a through 417n of the third group of neurons 417.

According to an embodiment, for the determination of the potential value for the corresponding neuron 403a, the neural processor 320 is configured to apply one or more nonlinear activation functions 149 on the corresponding results of the first dot product 120. As an example, the one or more nonlinear activation functions 149 may itself be represented as a weighted sum over basis functions (e.g., orthogonal polynomials), with adaptive coefficients, or some typical pre-defined activation functions. According to some embodiment, the application of the nonlinear activation functions is optional.

Based on a result of the application of the one or more nonlinear activation functions 149 on the corresponding results of the first dot product 120, the neural processor 320 is configured to determine the corresponding potential value for the corresponding neurons 403a of the group of neurons among the first plurality of neurons 403. Thereafter, the neural processor 320 is configured to generate a first output response 408 (as shown in FIGS. 4 and 5) based on the determined corresponding potential values 406. The output response 408 is a nonlinear temporal convolution output. Thus, the temporal convolution as shown in FIG. 4 is for the single neuron in single temporal convolution layer. Similarly, the temporal convolution operation may be performed for all the neurons in all the temporal convolution layers simultaneously in parallel. The temporal convolution between the plurality of temporal convolution layers occurring in parallel is explained in detail with reference to FIGS. 7 and 8. According to an embodiment, whenever the new input 404 is being received in the FIFO buffer 401, the old input 410 is discarded so that the new input 404 gets inserted and the other elements get shifted in the FIFO buffer 401 in each layer in a sliding window fashion. In particular, at each timestep, the FIFO buffer 401 is updated by pushing the new input 404 to the buffer 401 and discarding the oldest input 410 from the FIFO buffer 401. This essentially applies the sliding-window over the input stream to each layer, which is a core mechanism of the convolution operation according to the buffer mode. The detailed operation of the shifting of the temporal sequential data in the FIFO buffer 401 will be explained with reference to FIG. 8. According to some embodiments, a pointer corresponding to an address in the FIFO buffer 401 may get shifted instead of actually shifting of all the elements inside the FIFO buffer 401.

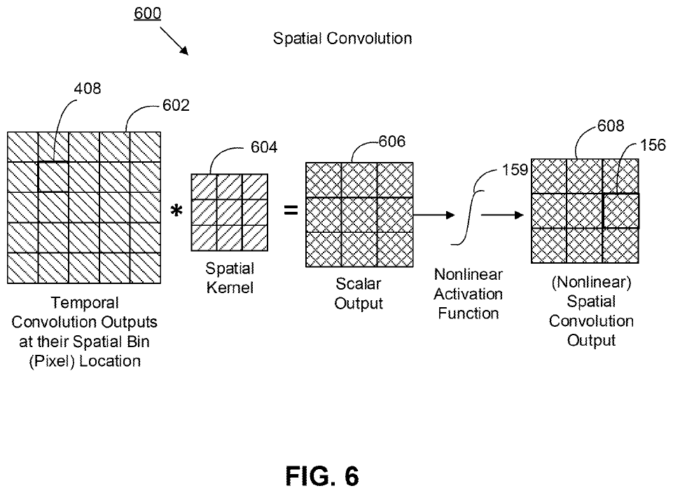

FIG. 6 illustrates an operation for determining the potential of a neuron in case the temporal convolution layer is followed by a spatial convolution layer in buffer mode operation, according to an embodiment of the present disclosure. The method 600 illustrates spatial convolution operation at the spatial convolution layer 1 of FIG. 4, in the case where the temporal convolution layer is followed by the spatial convolution layer. The method 600 will be explained by referring to the FIGS. 1 to 5. According to an example embodiment, for determining a potential of the neurons, the temporal convolution layer outputs 408 are generated for the complete temporal sequential data for each connection of the corresponding neuron of the first group of neurons among the first plurality of neurons 403 according to the operation disclosed in FIG. 5. Thereafter, the neural processor 320 is configured to assemble, for each connection of the corresponding neuron of the first group of neurons among the first plurality of neurons 403, each of a corresponding output value 408 of the performed first dot product 120 of the temporal sequence data within the corresponding FIFO buffer 401a of first plurality of FIFO buffers 401 with the corresponding temporal kernel value 402a among the corresponding group of the first temporal kernel values 402 in FIG. 4. According to an embodiment, the corresponding temporal convolution layer output values that are assembled into a spatial arrangement correspond to a new frame 602. Thereafter, the neural processor 320 is configured to perform a spatial convolution operation, by further convolving the new frame 602 with a spatial convolution kernel 604 of that current spatial layer to generate a scalar frame 606 including a plurality scalar outputs. Thereafter, the neural processor 320 is configured to apply one or more nonlinear activation functions 159 on the corresponding scalar output to generate a nonlinear spatial frame 608 including a plurality of nonlinear spatial convolution output 156 (as shown in FIG. 4 or 5). Thus, based on a result of the application of the one or more nonlinear activation functions on the corresponding scalar output, the neural processor 320 generates the nonlinear spatial convolution output 608 for the corresponding neurons 411a of the group of neurons among the first plurality of neurons 411. According to some embodiment, a corresponding nonlinear spatial convolution output 156 may be fed to the next temporal layer 417 as an input. In an embodiment, the spatial convolution operation 600 may be repeated whenever the spatiotemporal neural network 400 encounters any spatial convolution layer after the temporal convolution layer. In the case of a spatial convolution layer following a spatial convolution layer, the output 608 of the preceding layer becomes the input 602 of the following layer. With this arrangement, any layer, either temporal or spatial layer, may follow or be followed by any layer i.e., temporal or spatial layer. Based on the nonlinear spatial convolution output 608, the neural processor 320 may also be configured to determine the corresponding potential value for the corresponding neurons of the group of neurons among the plurality of neurons 411.

FIG. 7 illustrates the spatiotemporal operations of the neural network whereby a temporal convolution operation is performed at each of the plurality of temporal convolution layers followed by a spatial convolution operation performed at each of the plurality of the spatial convolution layers, itself followed by another temporal convolution operation, and another spatial convolution, and so on, for a plurality of alternating temporal and spatial convolution layers of the neural network 400 in the buffer mode, according to an embodiment of the present disclosure. According to an embodiment, method 750 illustrates a temporal convolution operation between the plurality of temporal convolution layers and a spatial convolution operation between the plurality of spatial convolution layers. The method 750 will be explained] with reference to FIGS. 1-6. As the temporal data sequences is continuously received at each of the temporal convolution layers 1 through N over a particular time window (time stamps) in each of the temporal convolution layer, the dot products of the temporal sequence in the temporal data sequence may be performed simultaneously in parallel. That is to say, the dot product in temporal convolution layer 1 is performed simultaneously in parallel with temporal convolution layers 2 through n in the spatiotemporal network 400. The utilization of parallel processing enables efficient execution of the convolution operations across the network. Particularly, it permits the training of the spatiotemporal network 400 using highly parallel computing machines, in contrast to the training of recurrent neural networks (RNNs). Nevertheless, for inference, due to the reduced memory requirements for edge devices, the operations may be performed in a serial manner instead of in parallel, or more effectively, be performed in the recurrent mode, which make the spatiotemporal neural network 400 suitable for implementation on edge devices.

According to an embodiment, after receiving and performing operation 600 on the first temporal sequence data as explained in the FIG. 6, the neural processor 320 simultaneously and in parallel, may be configured to receive from corresponding temporal data sequences over a second time window a second temporal sequence. The second temporal sequence is received into the second plurality of FIFO buffers that are allocated to a second group of neurons of the next temporal convolution layer.

Referring to the FIG. 4, as an example, the second temporal sequence is received into the second plurality of FIFO buffers 407a through 407n that are allocated to a second group of neurons of the second plurality of neurons 409a through 409n of the next temporal convolution layer 2. In a non-limiting example, consider that the second temporal sequence is received into the FIFO buffer 407a. As an example, the FIFO buffer 407a may be referred to in FIG. 7 as FIFO buffer 407. Accordingly, the temporal convolution using the FIFO buffer 407a for the second temporal data in the second temporal data sequence is performed based on the temporal convolution operation 450 as shown in FIG. 5. According to an embodiment, the temporal convolution is performed, for each connection of a corresponding neuron of the group of neurons among the second plurality of neurons. Accordingly, the neural processor 320 may be configured to perform the second dot product of the second temporal sequence that are present in the FIFO buffer 407 with a corresponding temporal kernel value of the temporal kernel 405 in the next temporal convolution layer for each connection of a corresponding neuron of the group of neurons among the second plurality of neurons. As an example, and referring to FIG. 4, at the neuron 409a, considering that the second temporal sequence is received at the second time window at the FIFO buffer 407a. Further, considering that the second temporal data sequences are stored within a corresponding FIFO buffer 407a of the first plurality of FIFO buffers 407. Accordingly, the neural network processor 320 may be configured to perform the second dot product with the corresponding kernel values in the second temporal kernel 405a among the corresponding group of the second temporal kernel 405. In a similar manner, the neural processor 320 may be configured to perform the dot product for the complete sequential data inputs to generate a corresponding output response as a result of each dot product.

After performing the second dot product, the neural processor 320 may be configured to determine a corresponding potential value for the corresponding neurons of the second group of neurons based on the performed second dot product. The result of the corresponding second dot product is a scalar output. The operation of the determination of the potential value for the corresponding neurons is same as explained above in FIG. 4 with respect to the temporal operation 450. Therefore, for the sake of brevity of the present disclosure, the detailed explanation of the same is omitted herein. Based on the determined corresponding potential values of the neuron of the temporal convolution layer 2, the neural processor 320 is configured to generate a second output response as shown in FIG. 7.

In an embodiment, based on the temporal convolution operation in each of the temporal convolution layer, one or more output response is generated from temporal convolution operation between a corresponding FIFO buffer and a corresponding temporal kernel. According to an embodiment, the output response that is generated by performing the temporal convolution operation 450 in a single neuron 403 of the temporal convolution layer 1 is a single response which is then passed to a neuron 409 of the next temporal convolution layer 2 (as shown in FIG. 4), at times via a spatial convolution layer 411. According to the example embodiment of FIG. 4, the output response 408 generated from the first temporal convolution layer (i.e., temporal convolution layer 1) is transmitted to the next temporal convolution layer (temporal convolution layer 2).

According to an embodiment, when the temporal convolution operation for all the temporal convolution layer is performed, the generated output responses from all the neurons of the temporal convolution layers are assembled in a new frame 602. The new frame 602 may also be directly the output of a preceding spatial layer 411. The generated new frame 602 is then convolved with the spatial kernel 604 to generate the scalar output 606 and thereafter the nonlinear activation function 159 is applied on the scalar output 606 to generate the nonlinear spatial convolution output 608. The operation for determining the potential of a neuron in a case where a spatial convolution layer follows either a temporal or another spatial convolution layer is explained in detail in FIG. 6. Therefore, for the sake of brevity, the detailed explanation is omitted herein. According to an example embodiment of FIG. 7, the generated nonlinear spatial convolution output at each of the temporal convolution layers 1, 2, and 3 is depicted with reference numeral 608.

According to an embodiment, the temporal data sequences are continuously received through the input interface 303, and there may be no spatial layers. Now as soon as any new input portion of the temporal data sequences is received in a FIFO buffer, the new input portion shifts in the first location of the FIFO buffer and the oldest input in the FIFO buffer is discarded. According to an example, shown in FIG. 7 as an when the new input portion 404 is received in the FIFO buffer 401 (i.e., FIFO buffer 1 of the temporal convolution layer 1), the oldest input 410 is discarded. Accordingly, the temporal convolution operation is performed using the data that remains after discarding the oldest input and the new input portion. The output response 408 of the temporal convolution layer 1 thus generated by using the aforesaid remaining data in the FIFO buffer is then passed to the FIFO buffer 407 of the next convolution layer (i.e., temporal layer 2) as a new input 412 for that layer. Likewise, in the FIFO buffer 407 (i.e., FIFO buffer 2) the oldest input 414 is discarded and the output response generated from the previous temporal layer (i.e., temporal layer 1) shifts in first location of the FIFO buffer 407. Further, the output response 408 of the temporal convolution layer 2 thus generated by using the aforesaid remaining data in the FIFO buffer is then passed to the FIFO buffer 415 of the next convolution layer (i.e., temporal layer 3) as a new input 416 for that layer. Likewise, in the FIFO buffer 415 (i.e., FIFO buffer 3) the oldest input 420 is discarded and the output response generated from the previous temporal layer (i.e., temporal layer 2) shifts in the first location of the FIFO buffer 415. Accordingly, the temporal convolution operation is performed using the data after discarding the oldest input and the output response coming from the previous temporal layer. Thus, every time a new input portion comes in, the oldest data in the FIFO buffer is discarded and temporal convolution operation 450 is performed over the data that remains after discarding the oldest input and the new portion of the data that comes in. The generated output hence produced is a single output that is passed to the next temporal layer for further processing. Due to the implementation of such unique technique using the FIFO buffers in each layer, the temporal convolution operation is streamlined bypassing the complications of a sliding time window.

As, every temporal convolution layer uses the FIFO buffer to cache the past inputs to the temporal convolution layer. The FIFO buffer depth may be optionally set equal to the temporal kernel size, to guarantee validity of the temporal convolution. In order to compute the temporal convolution as a dot product, the temporal kernel is made of one kernel value per timebin, and the kernel value are stacked into the FIFO buffer in the opposite temporal order than the FIFO buffer receiving the data. That is to say, the kernel value corresponding at the time of timebin 0, is actually stored in the last, most left cell of the buffer 402. And the kernel value corresponding at the oldest timebin is stored as the first, right most cell of the buffer 402.

According to one or more embodiments related to buffer mode operation of the present disclosure, the utilization of the FIFO buffer in each temporal convolution layer for the inputs eliminates the issues such as long latencies, overlapping/repeating computations, feeding a huge chunk of input data to a spatiotemporal neural network at once. Further, this also provides good memory utilization which is especially required in the edge devices and helps in reducing the latency and computation process extensively.

FIG. 8 illustrates a detailed operation of shifting of input data in a FIFO buffer in the buffer mode operation, according to an embodiment of the present disclosure. The operation 700 illustrates operation of shifting of the input data into the FIFO buffers in the temporal convolution layer 1 and the temporal convolution layer 2 during temporal convolution operation. In the example as depicted in FIG. 8, it is considered that the FIFO buffer of the temporal convolution layer 1 has a buffer size of 13 and has N1, O1 to O13 input data portions. The input data portions O1 to O13 indicates an older portion of convolution input. When a new input portion N1 is received at the FIFO buffer, then the oldest input data portion O13 is discarded and the neural processor 320 may configure to shift the FIFO buffer so as to store the new input portion N1 in the FIFO buffer. Further, at the first time processing 702, the neural processor 320 may generate an output response based on the convolution operation of the input data portions N1 to O12 with the plurality of kernel values. The generated output response is then passed on to the FIFO buffer of the next temporal convolution layer 2. Now, when the new input portion N2 is received at the FIFO buffer of the temporal convolution layer 1, then the oldest input data portion O12 is discarded and the neural processor 320 may configure to shift the FIFO buffer so as to store the received new input portion N2 in the FIFO buffer. Further, at the second time processing 704, the neural processor 320 may generate an output response based on the convolution operation of the input data portions N2 to O11 with the plurality of kernel values. The generated output response is then passed on to the FIFO buffer of the next temporal convolution layer 2. Likewise, when the next new input portion N3 is received at the FIFO buffer of the temporal convolution layer 1, then the oldest input data portion O11 is discarded and the neural processor 320 may configure to shift the FIFO buffer so as to store the received new input portion N3 in the FIFO buffer. Further, at the third time processing 706, the neural processor 320 may generate an output response based on the convolution operation of the input data portions N3 to O10 with the plurality of kernel values. The generated output response is then passed on to the FIFO buffer of the next temporal convolution layer 2. Likewise, when the next new input portion N4 is received at the FIFO buffer of the temporal convolution layer 1, then the oldest input data portion O10 is discarded and the neural processor 320 may configure to shift the FIFO buffer so as to store the received new input portion N4 in the FIFO buffer. Further, at the fourth time processing 708, the neural processor 320 may generate an output response based on the convolution operation of the input data portions N4 to O9 with the plurality of kernel values. The generated output response is then passed on to the FIFO buffer of the next temporal convolution layer 2. The process of shifting the input data portion and discarding the oldest data portion in the FIFO buffer continues as the new input portion is streamed. Although the shifting process is explained with the example of temporal convolution layer 1 and the temporal convolution layer 2, the same process may be applied to any number of temporal convolution layer present in the spatiotemporal neural network 400.

According to an embodiment, based on system requirement or user defined requirement, a group of temporal kernel values may be selected. Accordingly, the neural processor 320 may be further configured to recognize, based on a selection of a corresponding group of the first temporal kernel values, a change in a response pattern of one or more neurons in the group of neurons among the first plurality of neurons over a time period. Thereafter, the neural processor 320 may be further configured to the update the first temporal kernel values based on the recognized change in the response pattern.

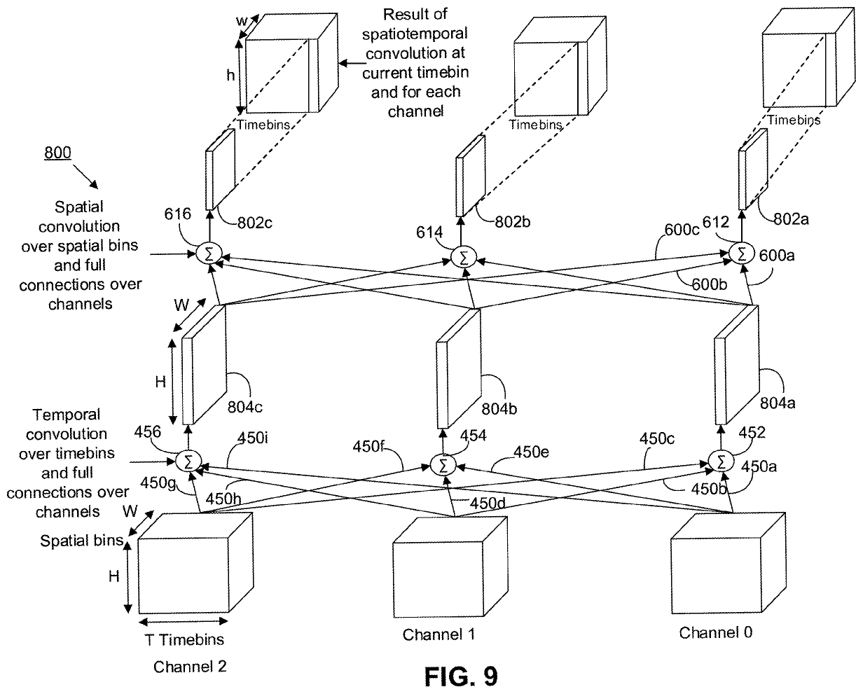

FIG. 9 illustrates an example scenario depicting an application of the buffer mode to a multi-channel operation of the spatiotemporal neural network 400 of FIG. 4, in accordance with an embodiment of the present disclosure. As described herein above with reference to FIG. 3 that the input interface 303 includes a plurality of input and output channels. Thus, in a non-limiting example, three input channels i.e., channel 0, channel 1, and channel 2 and three output channels (804a, 804b, 804c) are shown in FIG. 9 for describing the application of the buffer mode to the multi-channel operation of the spatiotemporal neural network 400. Also, as described herein above, the tensor representing the input to a temporal convolution layer has dimensions of input channels×width W×height H×T timebins. Thus, the neural processor 320 may perform the operations of the temporal convolution 450 for each of the W×H spatial bins. Each of the spatial bins is then weighted and summed together across the multiple input channels, here illustrated with three input channels (channel 0, 1, and 2) as a non-limiting example. The resulting temporal convolution and sum at each spatial bin provides a spatial frame at each of the output channels 804a, 804b, 804c. Note that each input to output channel connection can be assigned a separate temporal kernel (with a different set of coefficients). Since the temporal convolution operation 450 is explained above in detail with reference to FIG. 4, therefore for the sake of brevity of the disclosure, the detailed explanation of the same is omitted herein. In a non-limiting example, 9 combinations of the input/output channel operation are shown in FIG. 9, where 450a, 450b, 450c represent the operations of the temporal convolution 450 and summation across channels for output channel 804a. Similarly, 450d, 450e, 450f represent the operations of the temporal convolution 450 and summation across channels for output channel 804b, and 450g, 450h, 450i represent the operations of the temporal convolution 450 and summation across channels for output channel 804c. However, the summation takes place across all channels, and thus “n” of summations may take place depending on the configuration and implementation of the spatiotemporal neural network 400.

In the multi-channel operation of the spatiotemporal neural network 4400 in the buffer mode, the input interface 303 may receive the data sequence or the input data stream at each input channel i.e., channel 0, 1, and 2 and the neural processor 320 may receive, for the temporal convolution layer 1, the first temporal data sequence at each of the channels 0, 1, and 2 at the first time instance. Thereafter, the neural processor 320 may perform, simultaneously in parallel for each connection associated with a corresponding neuron of the group of neurons among the plurality of neurons 403a through 403n, a first dot product of the first temporal portion within the first plurality of FIFO buffers 401 with the plurality of group of first temporal kernels 402, the second dot product of the second temporal portion within the second plurality of FIFO buffers 407 with the plurality of groups of second temporal kernels 405 and the third dot product of the third temporal portion within the third plurality of FIFO buffers 415 with the plurality of group of third temporal kernels 413. Based on the results of the first dot product, the second dot product, and the third dot product, the temporal convolution output is generated for each channel by performing the temporal convolution operation 450 of FIG. 4. According to an embodiment, the temporal convolution output that is generated from the each of the dot products is then simultaneously in parallel assembled at operation 452, 454, 456 for each connection of the corresponding neuron of the group of neurons among the first plurality of neurons for each of the channel. Based on the corresponding assembled output values (804a, 804b, 804c), the neural processor 320 may generate an output response for each connection at each channel. As shown in FIG. 9, for each of the corresponding input channels 0, 1, and 2, the corresponding output values of the performed dot products correspond to a 2d tensor shaped output (H, W). For example, the corresponding output values of the performed dot products for channel 0 is assembled at 452 to generate the temporal convolution output data that is weighted and summed across channel 804a, the corresponding output values of the performed dot products for channel 1 is assembled at 454 to generate the temporal convolution output data that is weighted and summed across channel 804b, and the corresponding output values of the performed dot products for channel 2 is assembled at 456 to generate the temporal convolution output data that is weighted and summed across channel 804c. The assembling of the corresponding output values of the performed dot products may be a straight weighted summation across channels, but also any other type of assembling operation may also be performed by the neural processor 320 to combine the corresponding output values of the performed dot products from different channels into one channel. The performed dot product and weighted summation across channels corresponding to the channels 0, 1, and 2 may also be referred to as temporal convolution over timebins together with “full connections over channels”.

Following the temporal convolution, the neural processor 320 may also perform a plurality of spatial convolutions followed by full connections over channels 600a, 600b and 600c (as described above with reference to FIG. 6) for the corresponding combination of input and output channels, and may further assemble the results of spatial convolutions for the corresponding combination of input and output channels into a 2d tensor. In a non-limiting example, as shown in FIG. 9, the results of the spatial convolutions and full connections over channels corresponding to channel 0 is assembled as 612 into a 2D tensor 802a, the results of the spatial convolutions and full connections over channels corresponding to channel 1 is assembled as 614 into a 2D tensor 802b, and the results of the spatial convolutions and full connections over channels corresponding to channel 2 is assembled as 616 into a 2D tensor 802c. The aforementioned process is repeated for the desired number of output channels, to generate a final 3D output tensor shaped (C, H, W) at the current timebin. The current timebin is inserted in a temporal buffer that has the same structure as the bottom row (as shown in FIG. 9), to form the inputs to the temporal convolution for the next layer. The results of the spatial convolutions corresponding to the channels 0, 1, and 2 may also be referred to as spatial convolutions over “spatial bins” and “full connections over channels” without any deviation from the scope of the present disclosure.

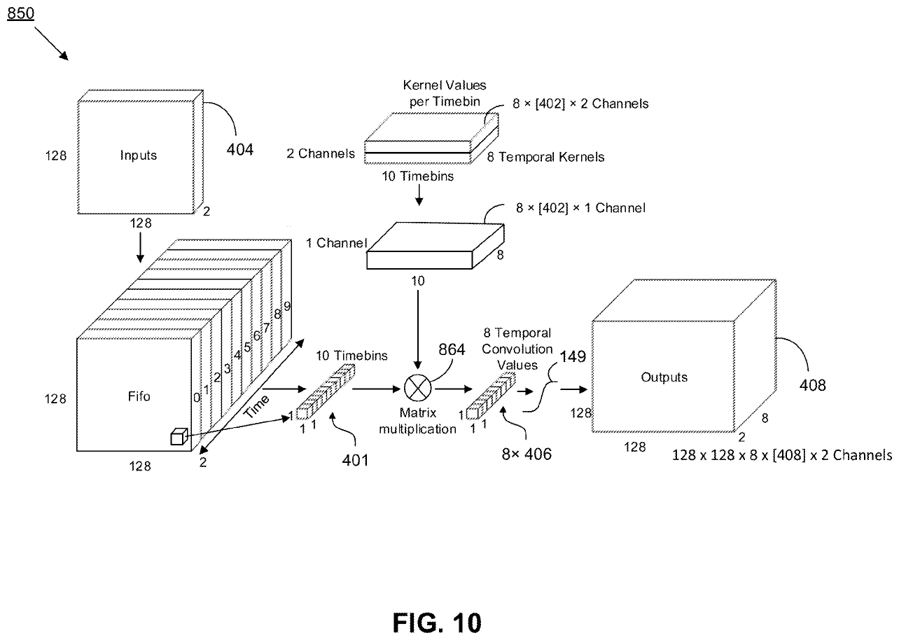

Referring now to FIG. 10 illustrates an example method 850 for performing multiple temporal convolutions in parallel by one or more temporal convolution layers of the spatiotemporal neural network 400 in the buffer mode in the multi-channel scenario, in accordance with an embodiment of the disclosure. The example method 850 depicts a scenario for performing temporal convolution in the buffer mode when each time a new incoming temporal data sequence is received at the input interface 303. The input interface 303 may receive each of the new incoming temporal data sequence in the timebins at multiple channels of the input interface 303. For the ease of explanation and sake of the brevity of the present disclosure, a description for FIG. 10 will be provided with reference to the temporal convolution layer 1 of the spatiotemporal neural network 400. As shown in FIG. 10, the FIFO buffer 401 of the temporal convolution layer 1 is represented by the tensor that has dimensions of Width×Height×Timebins. Each input channel among the two input channels as shown in FIG. 10 may receive the corresponding temporal data sequences as the input 404 in the corresponding FIFO buffer 401 at the corresponding timebins of the plurality of timebins 866.

The neural processor 320 may perform, for each input channel in the corresponding FIFO buffer 401, a matrix multiplication, implementing a dot product with each of the temporal kernels, of the corresponding temporal data sequence present in a corresponding FIFO buffer of the plurality of FIFO buffers 403a through 403n with the corresponding temporal kernels among the plurality of temporal kernel 402a through 402n per timebin to generate the scalar output 406.

In a non-limiting example, a group of 8 temporal kernels are used for performing the matrix multiplication 864. The neural processor 320 may perform the matrix multiplication 864 for each connection associated with the corresponding neuron of the group of neurons among the plurality of neurons 403a through 403n of the temporal convolution layer 1. Thereafter, in a non-limiting example as shown in FIG. 10, each matrix multiplication 864 provides the scalar output 406. Thereafter, one or more nonlinear activation functions 149 are applied on the corresponding results 406 of the matrix multiplication to generate a nonlinear temporal convolution output 408 temporal at one spatial bin and the generated nonlinear temporal convolution output 408 is further passed to a next convolution layer of the spatiotemporal neural network 400.

Although, a description for FIG. 10 is provided with reference to the temporal convolution layer 1 of the spatiotemporal neural network 400. However, the similar matrix multiplication 864 may be performed by the neural processor 320 in the buffer mode for each connection associated with the corresponding neuron of the group of neurons among the plurality of neurons of the other temporal convolution layers 2 through N of the spatiotemporal neural network 400. The matrix multiplication 864 may be performed by the neural processor 320 at each of the timebins when the FIFO buffer of the corresponding temporal convolution layers is updated.

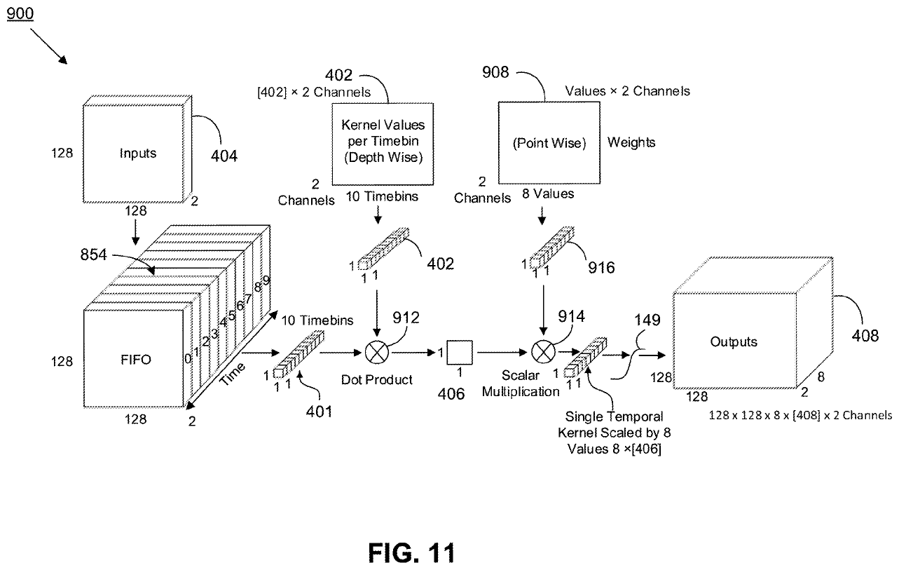

Referring now to FIG. 11 illustrates an example method 900 for performing a temporal convolution scaled by multiple values by one or more temporal convolution layers of the spatiotemporal neural network 400 in the buffer mode in the multi-channel scenario, in accordance with an embodiment of the disclosure. The example method 900 depicts a scenario for performing the temporal convolution in the buffer mode when each time the new incoming temporal data sequence is received at the input interface 303. For the ease of explanation and sake of the brevity of the present disclosure, a description for FIG. 11 will be provided with reference to the temporal convolution layer 1 of the spatiotemporal neural network 400. Also, for ease of explanation, the same FIFO buffer 401 as in FIG. 10 is used for the explanation of FIG. 11. Each input channel among the two input channels as shown in FIG. 11 may receive the corresponding temporal data sequences as the input in corresponding timebins of the plurality of timebins 866.

In the method 900, at first the neural processor 320 may perform, for each input channel in the corresponding timebins of the plurality of timebins 866, a dot product 912 of each of the temporal sequence of the temporal convolution layer 1 with a plurality of depth wise temporal kernel values 910 per timebin. As a result of the performed dot products, a plurality of output scalar values may be generated. In a non-limiting example, as shown in FIG. 11, one output scalar value 406 as a result of the corresponding dot product 912 may be generated. Secondly, in the method 900, the neural processor 320 may perform, for each input channel a scalar multiplication 914 of the corresponding output scalar values 406 that are generated as the result of the performed dot products 912 with a group of point wise values 916 among the plurality of values 908 to generate the output values scaled by multiple values. For example, as shown in FIG. 11, for the first input channel, the neural processor 320 performed the scalar multiplication 914 of the corresponding scalar output value with the first group of point wise values 916 among the plurality of values 908. In a non-limiting example, a group of 8 values are used for performing the scalar multiplication 914. The neural processor 320 may perform the scalar multiplication 914 for each connection associated with the corresponding neuron of the group of neurons among the plurality of neurons 403a through 403n of the temporal convolution layer 1. Thereafter, in a non-limiting example as shown in FIG. 11, each of the scalar multiplication 914 that is followed the dot product operation 912 provides an output result i.e., a single temporal kernel scaled by 8 filter values. Thereafter, one or more nonlinear activation functions 149 are applied on the corresponding output results of the scalar multiplication 914 followed by the dot product operation 912 to generate the nonlinear temporal convolution output 408 at one spatial bin. The generated nonlinear temporal convolution output 408 is further passed to the next convolution layer of the spatiotemporal neural network 400.

Although, the description for FIG. 11 is provided with reference to the temporal convolution layer 1 of the spatiotemporal neural network 400. However, the similar separable temporal convolution as shown using the method 900 may be performed by the neural processor 320 in the buffer mode for each connection associated with the corresponding neuron of the group of neurons among the plurality of neurons of the other temporal convolution layers 2 through N of the spatiotemporal neural network 400.

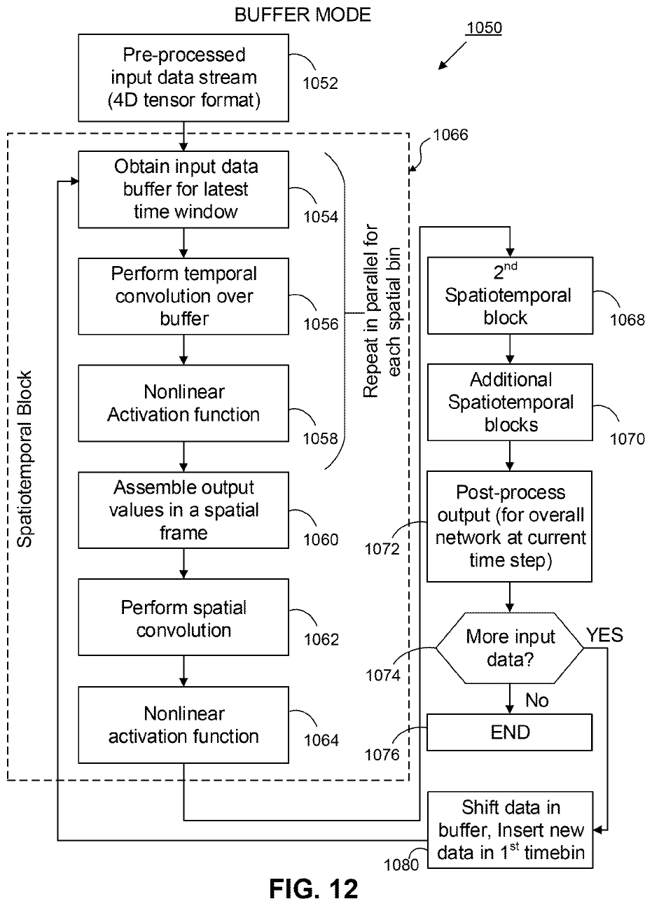

FIG. 12 is a flow chart of a method 1050 performed by a processing system 300 including the neural processor 320 for performing temporal convolutions followed by spatial convolutions in the buffer mode using one or more convolution layers of the spatiotemporal neural network 400, in accordance with an embodiment of the disclosure. The method 1050 (at step 1052), includes receiving a pre-processed input data stream at the input interface 303 of the neural network system 300. As an example, the neural processor 320 may read the pre-processed input data stream that is received at the input interface 303 of the neural network system 300. The received input data stream may comprise, typically, 4D tensor data, generally read by the spatiotemporal neural network 400 as the stream of 3D tensor data. In a non-limiting example, the received input data stream may be generated by frame-based cameras providing RGB color channels at specific frame rates. In another non-limiting example, signals from event-based cameras may also be used as the input data stream but may require pre-processing such that one event may contribute to one or more timebins in order to provide a 4D tensor data format such as channel (1D), space (2D) and time (1D). For example, if the camera is frame-based, then the stream of frames captured by the camera may be directly fed into the spatiotemporal neural network 400 in the form of a 4D tensor of size (RGB channels)×(number of pixels along sensor's width)×(number of pixels in sensor's height)×(number of frames). Further, in another example, if the camera is event-based, then preprocessing is performed on the input data stream to convert the input data stream into a 4D tensor. The neural processor 320 may be configured to process the received input data stream for each channel or combination of channels as inputs to the spatiotemporal neural network 400. Although, in one or more embodiments disclosed herein, the neural processor 320 processes one or more of the channels of the input data stream i.e., 4D tensor data. However,, in some embodiments, the neural processor 320 may process each of the channels internal to the spatiotemporal neural network 400 by processing, aggregating and combining the results of temporal and spatial convolution operations for every channel path i.e., for each of the channels in the spatiotemporal neural network 400.

The neural processor 320 processes the received input data stream through a first spatiotemporal block (ST-block) 1066 (surrounded by dashed box) followed by a 2nd ST-block 1068 and additional ST-block(s) 1070. It is to be noted that the first ST-block 1066, the second ST-block 1068 and the additional ST-block(s) 1070 as shown in FIG. 12 are for illustration purpose only and may not be construed as limiting in nature for a person skilled in the art.

In an embodiment, the operations in the first ST-block 1066 comprises one temporal convolution operation followed by one spatial convolution. In some embodiments, the first ST-block 1066 may contain more than one consecutive temporal convolution operations and/or more than one consecutive spatial convolutions. In one embodiment, the temporal convolution step is applied separately to each spatial bin (pixel) of each input image frame of the input data stream, and thus, by processing in one temporal convolution, multiple frames in time of the same spatial bin (pixel). The spatial convolution step is applied to each input image frame of the input data stream, and thus, by processing in one spatial convolution, multiple spatial bins (pixels) at one timebin (frame). The neural processor 320 performs the temporal convolution at a particular time step at each of the one or more temporal convolution layers 1 through N sequentially or in parallel. Similarly, the neural processor 320 performs the spatial convolution at each of the one or more spatial convolution layer of the spatiotemporal neural network 400.

The method steps 1054 to 1064 of the method 1050, corresponds to operations performed by the neural processor 320 in the first ST-block 1066. At step 1054, the neural processor 320 obtains, from the received input data stream, first input data as the first temporal data sequence at the first time instance. At step 1056, the neural processor 320 performs temporal convolution of temporal kernel on the obtained first temporal data buffer to perform temporal convolution of temporal kernel over corresponding FIFO buffer of the plurality of FIFO buffers through the one or more temporal convolution layers 1 through N of the spatiotemporal neural network 400. In particular, a dot product is performed on the obtained first temporal data in the FIFO buffer with a corresponding temporal kernel of the one or more temporal convolution layers 1 through N of the spatiotemporal neural network 400. After performing the dot product, scalar output is generated from each of the dot product. A detailed explanation related to the method step 1056 is already described above herein with regard to the temporal operation 450 of FIG. 5. Therefore, for the sake of brevity of the disclosure, the detailed explanation of the same is omitted herein. At step 1058, the neural processor 320 is configured to apply the one or more nonlinear activation functions 149 on the generated one or more temporal convolution output values to convert the one or more temporal convolution output values into one or more nonlinear temporal convolution output values. In a non-limiting example, the one or more nonlinear activation functions 149 may include ReLU or a sigmoid function. The operations of steps 1054 through 1058 are repeated in parallel for each spatial bin. Further, at step 1060, the neural processor 320 assembles the one or more nonlinear temporal convolution output values at the spatial bin locations in a spatial frame. At step 1062, the neural processor 320 performs a spatial convolution operation on the one or more nonlinear temporal convolution output values in the spatial frame using the one or plurality of spatial kernels. Also, the neural processor 320 may select a plurality of parameters including a desired value of kernel size, stride, padding, a subsequent nonlinear activation function, etc. and may perform, using any spatial convolution methods known in the art, the spatial convolution based on the selected plurality of parameters. At step 1064, the neural processor 320 is configured to apply a nonlinear activation function on the outputs of the spatial convolution.

When the operations steps 1052 to 1064 of the first ST-block 1066 are performed for the first temporal data sequence of the temporal data sequences at the first time instance, then output data from the first ST-block 1066 is passed onto the second ST-block 1068. Further, after completion of the processing at the ST-block 1070, the neural processor 320, at step 1072, may perform post-processing of the output data for overall spatiotemporal neural network 400 for the current time instance.

In addition, to take advantage of parallel processing hardware, the first ST-block 1066 may be configured to fetch data from the next time instance (if available) while subsequent ST-blocks 1068 and 1070 may still process the output data from the current time instance. As an example, at step 1074, the neural processor 320, determines whether more input data is available at the input interface 303 after completing the processing at the first ST-block 1066. If at step 1074, it is determined that more input data is available, then at the step 1080, the neural processor 320 shifts the data in the FIFO buffer and insert the new available data in the first timebin of the FIFO buffer for further processing. The same applies to other ST-blocks 1068 and 1070 of the spatiotemporal neural network 400. This method of processing input data at different time instances at successive ST-blocks may be referred to as pipelining without any deviation from the scope of the present disclosure.

Further, if at step 1074, it is determined that no more input data is available, the method 1050 comes to an end at step 1076.

FIG. 13 illustrates an example representation of the spatiotemporal neural network 500 including the spatial and temporal convolution neural layers and the plurality of neurons along with the working of the spatiotemporal neural network in the recurrent mode, in accordance with an embodiment of the disclosure. The spatiotemporal neural network 500 includes one or more spatial convolution layers including a spatial convolution layer 1, and one or a plurality of temporal convolution layers, i.e., temporal convolution layers 1 through N.

In addition, the memory 301 is further configured to implement the spatiotemporal neural network 500 and store a plurality of temporal kernel coefficients for a corresponding temporal convolution layer of the plurality of convolution layers 1 through N. It is to be noted that the temporal kernel coefficients may be different for each neuron of the spatiotemporal neural network 500. The memory 301 is further configured to store a memory vector 140 as an internal state of the corresponding temporal convolution layers and a first set of projection vectors or projection coefficients, which may also be referred herein as the reference matrix 141. A projection vector 141 projects the input data 102 onto the same set of basis functions that is used in the temporal kernel expansion, which consists of sum over the product of the kernel coefficients with each of the basis functions. Also, to update the memory vector 140, the memory 301 is configured to store a second set of coefficients as a state operator or a reference matrix 144 that is used to generate the basis functions. The reference matrix 144 and the projection vector 141 is determined based on one or more basis functions that are used to construct one or more complex functions, such as but not limited to the temporal kernels, or a set of parameters that evolve through training, without specific interpretations.

The spatiotemporal neural network 500 is configured to perform one or more temporal convolutions using one or more temporal convolution layers of the spatiotemporal neural network 500 and one or more spatial convolution using one or more spatial convolution layers of the spatiotemporal neural network 500. In particular, the spatiotemporal neural network 500 is configured to perform hierarchical spatiotemporal convolutional processing. A corresponding temporal layer of the spatiotemporal neural network 500 includes a plurality of neurons. For example, the temporal convolution layer 1 includes a first plurality of neurons 501a through 501n, the temporal convolution layer 2 includes a second plurality of neurons 503a through 503n, and the temporal convolution layer 3 includes a third plurality of neurons 507a through 507n. The spatial convolution layer includes a plurality of neurons 505a through 505n. The sequence of the plurality temporal convolution layers and the spatial convolution layer as shown in FIG. 13 is exemplary and is not intended to limit the scope of the embodiments of the present disclosure. For example, the spatial convolution layer 1 may be arranged before or after any of the temporal convolution layer 1 or 2. Similarly, the corresponding temporal convolution layers 1 through N may be arranged in any other alternate sequence without any deviation from the scope of the present disclosure.

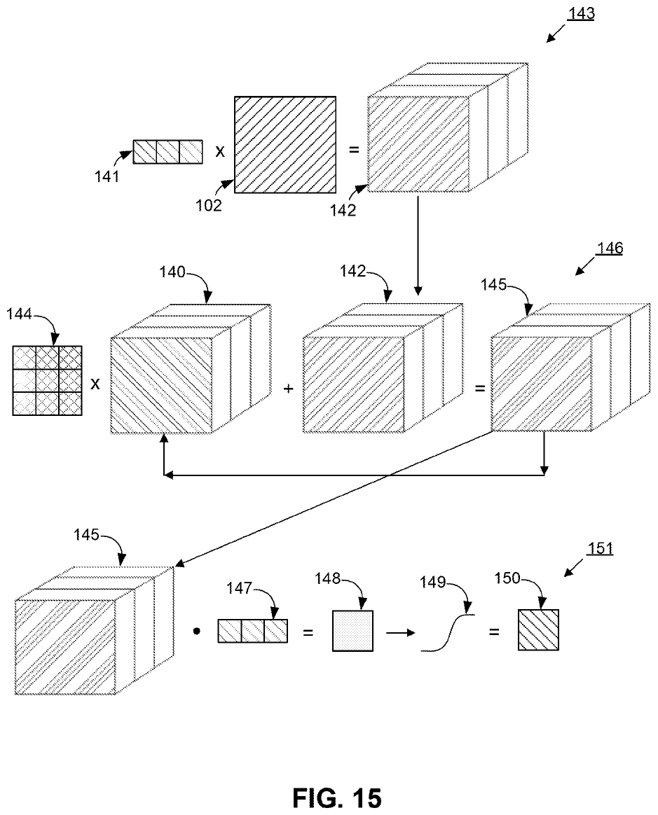

Further, a configuration of the spatiotemporal neural network 500 defines one or more connections between the plurality of neurons of the corresponding temporal convolution layers 1 through N and the spatial convolution layer 1. The neural processor 320 may be configured to perform the one or more temporal convolutions and spatial convolutions using neurons of the one or more temporal convolution layers and the spatial convolution layer of the spatiotemporal neural network 500. In particular, the neural processor 320 may be configured to perform the one or more temporal convolutions by performing a series of operations on each of the temporal data sequences utilizing the plurality of reference matrices (141, 144), the memory vector 140, and the plurality of temporal kernel coefficients 147. A detailed description of the series of operations for performing the temporal convolution is described below in the forthcoming reference paragraph with reference to FIGS. 15 to 19 of the drawings.

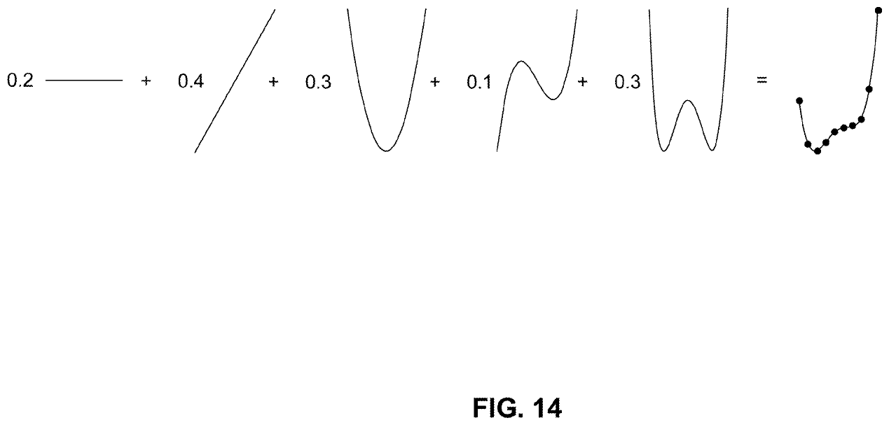

Further, in one or more embodiments disclosed herein in context with the recurrent mode, each temporal kernel of a plurality of temporal kernels for the corresponding temporal convolution layer of the plurality of convolution layers 1 through N is represented as a sum of basis functions, such as orthogonal polynomials, weighted by the temporal kernel coefficients. The temporal kernel coefficients may be optimized via training of the spatiotemporal neural network 500. Each of spatial kernels for the corresponding spatial convolution layers may also be represented by a sum of basis functions, such as orthogonal polynomials, in each dimension to generate a separable spatial kernel of one dimension each or by a sum of basis functions, such as orthogonal polynomials, each basis function being multidimensional (2D, 3D or more). FIG. 14 illustrates an example representation of a uniformly sampled temporal kernel which is represented as a sum of a set of kernel coefficients multiplied by the basis functions, here the orthogonal Legendre polynomials, in accordance with an example embodiment of the disclosure. The representation of the temporal kernel as the sum of orthogonal polynomials weighted by the temporal kernel coefficients allows the temporal kernel to span over a long time-window while being parameterized by only a few coefficients. This effectively increases a temporal receptive field of each of the temporal convolution layers 1 through N while reducing a risk of over-parameterization.

In particular, the temporal kernels that are represented as the sums of orthogonal polynomials may be used directly in the recurrent mode for efficient online inference. This is especially useful for mobile devices and edge computing to perform temporal convolutions at every time instance (timebin). Thus, the spatiotemporal neural network 500 disclosed herein becomes an efficient neural network whose temporal operations are configured as linear recurrent operations in nonlinear temporal layers, in contrast to many recurrent neural networks that have nonlinear recurrent operations, and that can be used to perform efficient online inference over a spatiotemporal data stream.

The representation of the temporal kernels as the sums of basis functions, such as orthogonal polynomials, provides a continuous temporal kernel representation, which allows the handling of temporal data sequences that are not sampled uniformly in time. Thus, a less number of parameters are required for training of the spatiotemporal neural network 500 (i.e., increased backpropagation stability), and less number of parameters needs to be stored for inference. Also, the representation of the temporal kernels as the sums of basis functions, for example orthogonal polynomials, allows a significant reduction in free parameters (parameters that can be trained), increasing stability and generalizability of the spatiotemporal neural network 500. Also, in a case where the inference is performed on hardware, the representation of the temporal kernels as the sums of basis functions, including orthogonal polynomials, helps in reduction of the memory requirements of the hardware, as the temporal kernels may be stored as polynomial coefficients and may be retrieved “on the fly” as needed by one or a plurality of neuron(s) in one or a plurality of layer(s). This allows the spatiotemporal neural network 500 to be configured to operate in basis function coefficient space, for example, polynomial coefficient space, and allows for greater efficiency for inference.

Each of the temporal convolution layers 1 through N of the spatiotemporal neural network 500 is configured to perform a temporal convolution between the temporal kernels and the inputs. The temporal convolution between the temporal kernels and the inputs is a linear operation. Thus, the spatiotemporal neural network 500 may be trained efficiently utilizing GPU hardware similar to CNN. The training of the spatiotemporal neural network 500 may be performed using optimization algorithms such as but not limited to adaptive moment estimation (Adam).

The temporal kernel coefficients may be trained along with the entire spatiotemporal neural network 500 in an end-to-end fashion, while the basis functions, which may be orthogonal polynomials, may be kept fixed or may be trained as well. That is the reference matrices (projection vector 141) and (state matrix 147) as shown in FIG. 15 may be constituted or not of trainable parameters. In an embodiment, a number of temporal kernel coefficients may be made much smaller than the number of timebins over which the temporal kernel is defined, thus than the number of temporal kernel values, once the temporal kernel is segmented into timebins.

The spatiotemporal neural network 500 may be further configured to operate in a fixed and uniform timebin size (τ_{b}) throughout the network, or the spatiotemporal neural network 500 may be further configured to operate in a variable or non-uniform timebin size, depending on the one or more embodiments disclosed herein. The timebin size is different from a time window of the temporal kernel, which is how far the temporal kernel may look back in time. The time window of the temporal kernel may be denoted as T, which is the time period over which the temporal kernel is defined. If the temporal kernel is discretized across timebins, the value of the kernel at each timebin form together the temporal kernel values. The time window of the temporal kernel and the timebin size, for a fixed and uniform, timebin size, is related as:

$$T = M {τ}_{b} , \qquad ( 1 )$$

where, M is the number of temporal kernel values (temporal kernel size).

In one or more embodiments described herein, the input of the one or more convolution layers of the spatiotemporal neural network 500 are represented as 4D tensors of size (number of input channels)×(number of spatial bins over width)×(number of spatial bins over height)×(kernel size, or number of timebins over temporal kernel), and the temporal kernels are represented as 1D tensors of size (kernel size), which is the number of timebins selected to discretize the temporal kernel If the inputs, outputs, and kernels of the corresponding temporal convolution layers of the spatiotemporal neural network 500 is represented as I, u, h, respectively, then a temporal convolution operation at each of the corresponding temporal convolution layers may be given by equation (2) as shown below:

$$u ( d , i , j , t ) = {\sum }_{c , m} h ( c , d , m {τ}_{b} ) \times I ( c , i , j , t - m {τ}_{b} ) \qquad ( 2 )$$

where,
c and d indexes the input and output channels, respectively,
i and j indexes the horizontal and vertical locations, respectively,
t corresponds to a current timestep, and

$$m = \{ 0 , 1 , … , M - 1 \} .$$

In one or more embodiments, the temporal kernels of the corresponding temporal convolution layers of the spatiotemporal neural network 500 are defined on a finite time interval. Thus, each temporal kernel (h) may be expanded as the sum of orthogonal polynomials at a finite interval on a real line, such as the Legendre, Chebyshev, Gegenbauer, or Jacobi polynomials. The orthogonality condition of such polynomials may be defined through a “weight” function. If a polynomial function basis is given by ( [symbol] ), then each of the temporal kernel of the corresponding temporal convolution layers of the spatiotemporal neural network 500 may be represented as the sum of orthogonal polynomials as shown below in equation (3):

$$h ( c , d , m {τ}_{b} ) = {\sum }_{n = 0}^{N} {a}_{n} ( c , d ) {𝒫}_{n} ( - 1 + 2 \frac{m}{M - 1} ) \qquad ( 3 )$$

where, n denotes a degree of the polynomial (with N being the maximum degree in the polynomial expansion), and a denotes polynomial coefficients that are trainable parameters of a temporal convolution layer. It is to be noted that rescaling of the polynomial function basis

$$- 1 + 2 \frac{m}{M}$$

is to restrict the inputs to the polynomial function basis in the interval [−1, 1]. In the context of temporal convolution, a person skilled in the art may interpret the polynomial function basis to be “stretched” into the interval [t−T, t]. Thus, the temporal kernels are defined at the finite number of points in time, that is at each timebin, or in particular at the time instances

$$\{ - 1 , - 1 + \frac{2}{M - 1} , … , 1 - \frac{2}{M - 1} , 1 \} .$$

FIG. 15 illustrates an example scenario depicting a method of performing temporal convolution at temporal convolution layer 1 of the spatiotemporal neural network 500 in the recurrent mode, in accordance with an embodiment of the disclosure. It is to be noted that only one input channel and one output channel are considered for the description of the method of performing temporal convolution at temporal convolution layer 1, the ease of explanation, and the sake of brevity of the present disclosure.

The method as shown in FIG. 15 is divided into two processing stages i.e., a recurrent stage 143 and 146 and a feedforward stage 151. In a first portion 143 of the recurrent stage, the neural processor 320 first receives a data point of current time 102. Secondly, the neural processor 320 projects the received data point 102 by the reference matrix 141 (i.e., the projection vector 141) and thereby determines a projected input 142. Further, in a second portion 146 of the recurrent stage, at first, for the received temporal data sequence 102, the neural processor 320 transforms the memory vector 140 by multiplying the memory vector 140 with the reference matrix 144. Secondly, the neural processor 320 generates an updated memory vector 145 by adding the transformed memory vector with the projected input 142. In other words, the neural processor 320 updates the internal state of the recurrent layer by adding the projected temporal input 142 to the current internal state of the recurrent layer.

In the feedforward stage 151, the neural processor 320 performs, for each connection associated with a corresponding neuron of a group of neurons among the plurality of neurons 501a through 501n at the recurrent layer, a dot product of the updated memory vector 145 with the plurality of temporal kernel coefficients 147. The dot product is performed to pass information of the current recurrent layer as output to the next layer of the spatiotemporal neural network 500, for example, another recurrent layer or convolution layer. Also, as can be seen from FIG. 13 and FIG. 15, a result of the performed dot product of the memory vector 145 and the plurality of temporal kernel coefficients 147 i.e., a scalar value 148 is given as the output to the temporal convolution layer 2. More specifically, in the feedforward stage 151, the memory vector 145 i.e., the new internal state is directly dotted with the temporal kernel coefficients 147 instead of the temporal kernel values, which performs the temporal convolution in the coefficient space and thus yields the scalar value 148. This obviates the need to explicitly compute or store the temporal kernel values.

Further, in the feedforward stage 151, the neural processor 320 determines a corresponding potential value for the corresponding neurons based on the performed dot product of the updated memory vector 145 and the plurality of temporal kernel coefficients 147. In order to determine the corresponding potential value for the corresponding neurons, at first, the neural processor 320 applies one or more activation functions 149 (herein also referred to as a nonlinear activation function 149) on a corresponding result of the dot product 148 (herein also referred to as the scalar value 148). Thereafter, the neural processor 320 determines the corresponding potential value for the corresponding neurons based on a result of the application of the one or more activation functions 149 on the corresponding result of the dot products. Further, after determining the corresponding potential value for the corresponding neurons, at last, the neural processor 320 generates an output response 150 corresponding to the temporal convolution layer 1 based on the determined corresponding potential values of the corresponding neurons. It is to be noted that the neural processor 320 may use a different set of coefficients to connect each input and output channel pair, and the results of the corresponding dot products may be summed to generate the spatial feature 150 for each output channel.

In the recurrent mode, the spatiotemporal neural network 500 stores a compressed representation of the past inputs (i.e., internal state) at each of the recurrent layers 1 through N, and thus maintains and updates the internal state of each of the recurrent layers 1 through N. Furthermore, the memory and computation requirements of the spatiotemporal neural network 500 are scaled with the temporal kernel size, but only be scaled with the number of temporal kernel coefficients, which in practice is orders of magnitude smaller than the temporal kernel size. Therefore, the spatiotemporal neural network 500 can be trained efficiently and then the spatiotemporal neural network 500 may perform the inference over long temporal data sequences with high accuracy in comparison to conventional RNNs.

Although, FIG. 15 only depicts the recurrent operations performed by the neural processor 320 for a single channel. However, the neural processor 320 may perform the temporal convolution operations for multiple input and output channels in a similar manner as described herein with respect to FIG. 15 of the drawings. For example, the neural processor 320 may receive multiple data sequences separately for the multiple input channels. For example, the neural processor 320 may project the reference matrix 141 onto the received data to the second input channel and thereby may determine another projected temporal input 142 based on the projection of the data by the reference matrix 141. Further, for the data received to the second channel, the neural processor 320 may transform the updated memory vector 145 by multiplying the reference matrix 144 with the updated memory vector 145. Thus, the neural processor 320 may generate a new memory vector by adding the transformed updated memory vector with the determined projected input 142. Taken over all the channels, in the feedforward stage 151, the neural processor 320 may perform, for each connection associated with the corresponding neuron of the group of neurons among the plurality of neurons 501a through 501n, a new dot product of the newly generated memory vector with the plurality of temporal kernel coefficients 147. Also, the neural processor 320 may store the updated memory vector 145 or the newly generated memory vector in the memory 301 at each consecutive time instance when the new memory vector is generated.

In one or more embodiments described herein with reference to the recurrent mode, the neural processor 320 may further transform the newly generated memory vector at a consecutive time instance at which a new temporal data sequence of the temporal data sequences is received at the input channel. Also, the neural processor 320 may repeatedly generate the new memory vector until the updated memory vector is transformed for each of the temporal data sequences received at the input channel.

Further, the output response 150 corresponding to each of the output channels may be passed to a spatial convolution layer (for example, spatial convolution layer 1), and a spatial convolution operation is further performed by convolving the output response 150 with a spatial kernel of the spatial convolution layer. This spatial convolution operation provides a spatially convoluted output on which the one or more activation functions 149 is applied to generate a nonlinear spatial convolution output 156.

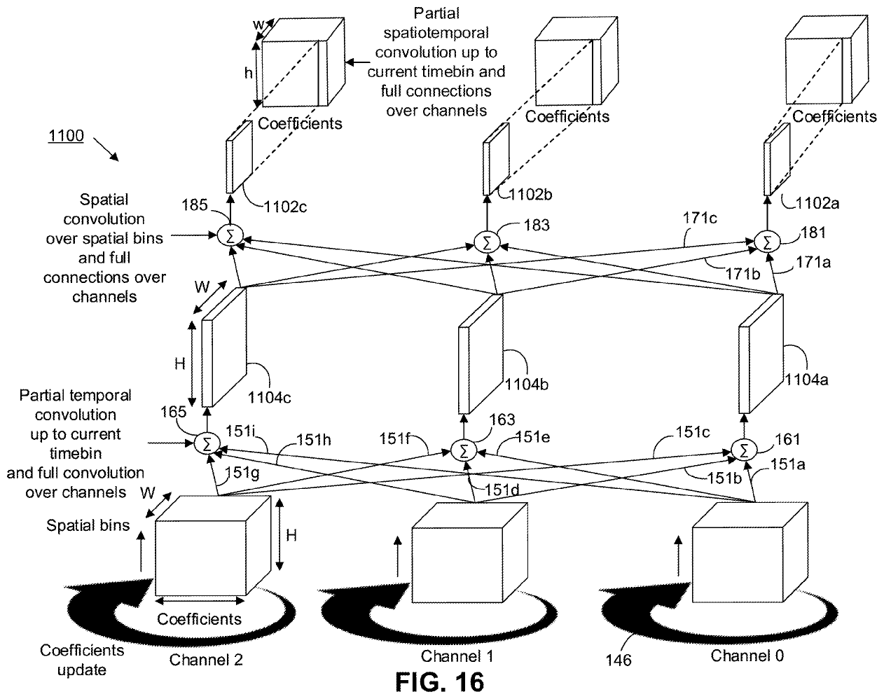

FIG. 16 illustrates an example scenario depicting an application of the recurrent mode to a multi-channel operation of the spatiotemporal neural network 500 of FIG. 13, in accordance with an embodiment of the present disclosure. As described herein above with reference to FIG. 3 that the input interface 303 includes a plurality of input and output channels. Thus, in a non-limiting example, three input channels i.e., channel 0, channel 1, and channel 2 and three output channels (1104a, 1104b, 1104c) are shown in FIG. 16 for describing the application of the recurrent mode to the multi-channel operation of the spatiotemporal neural network 500. Also, as described herein above, the tensor representing the internal state of the temporal convolution layers 1 through N has dimensions of Width×Height×Coefficients×input channels. Thus, the neural processor 320 performs the operations of the feedforward step 151 for each combination of the input/output channels. Therefore, in a non-limiting example, 9 combinations of the input/output channel operation are shown in FIG. 16, where 151a, 151b, and 151c represent the operations of the feedforward step 151 for output channel 1104a. Similarly, 151d, 151e, and 151f represent the operations of the feedforward step 151 for output channel 1104b, and 151g, 151h, and 151i represent the operations of the feedforward step 151 for output channel 1104c. Note that each input to output channel connection can be assigned a separate set of output projection weights. However, there may present “n” number of combinations of input/output channel operation depending on the configuration and implementation of the spatiotemporal neural network 500.

In the multi-channel operation of the spatiotemporal neural network 500 in the recurrent mode, the input interface 303 may receive the data sequence or the input data stream at each input channel i.e., channel 0, 1, and 2 and the neural processor 320 may receive, for the temporal convolution layer 1, the first temporal data sequence at each of the channels 0, 1, and 2 at the first time instance. Thereafter, the neural processor 320 may perform, simultaneously in parallel for each connection associated with a corresponding neuron of the group of neurons among the plurality of neurons 501a through 501n, a first dot product of the generated memory vector 145 with the first group of temporal kernel coefficients, a second dot product of the generated memory vector 145 with the second group of temporal kernel coefficients, and a third dot product of the generated memory vector 145 with the third group of temporal kernel coefficients. The performed dot product corresponding to the channels 0, 1, and 2 may also be referred to as partial temporal convolution up to a current timebin i.e., current time instance without any deviation from the scope of the present disclosure.

Further, in order to determine the corresponding potential value for the corresponding neurons in the multi-channel operation of the recurrent mode, at first, the neural processor 320 may apply the one or more activation functions 149 on a corresponding output value of the performed dot products corresponding to the channels 0, 1, and 2. Thereafter, the neural processor 320 may determine the corresponding potential value for the corresponding neurons based on a result of the application of the one or more activation functions 149 on the corresponding output values of the performed dot products corresponding to the channels 0, 1, and 2. As shown in FIG. 16, for each of the corresponding input channels 0, 1, and 2, the corresponding output values of the performed dot products correspond to a 2d tensor-shaped output (H, W). Once the corresponding output values of the performed dot products are generated, then the neural processor 320 assembles (161, 163, and 165), simultaneously in parallel, the corresponding output values of the performed dot products to generate the temporal convolution output data for corresponding channels 0, 1, and 2. For example, the corresponding output values of the performed dot products for channel 0 are assembled as 161 to generate the temporal convolution output data 1104a, the corresponding output values of the performed dot products for channel 1 are assembled as 163 to generate the temporal convolution output data 1104b, and the corresponding output values of the performed dot products for channel 2 is assembled as 165 to generate the temporal convolution output data 1104c. The assembling of the corresponding output values of the performed dot products may be a straight summation, but also any other type of assembling operation may also be performed by the neural processor 320 to combine the corresponding output values of the performed dot products into one.

Following the temporal convolution, the neural processor 320 may also perform a plurality of spatial convolutions 171a, 171b, and 171c (as described above with reference to FIG. 6) for the corresponding combination of input-output channels, and may further assemble the results of spatial convolutions for the corresponding combination of input-output channels into a 2d tensor. In a non-limiting example, as shown in FIG. 16, the results of the spatial convolutions corresponding to channel 0 are assembled as 181 into a 2D tensor shaped output (h, w) 1102a, the results of the spatial convolutions corresponding to channel 1 are assembled as 183 into a 2D tensor-shaped output (h, w) 1102b, and the results of the spatial convolutions corresponding to channel 2 is assembled as 185 into a 2D tensor-shaped output (h, w) 1102c. The aforementioned process is repeated for the desired number of output channels, to generate a final 3D output tensor shape (C, H, W). The results of the spatial convolutions corresponding to the channels 0, 1, and 2 may also be referred to as spatial convolutions over “spatial bins” and “full connections over channels” without any deviation from the scope of the present disclosure.

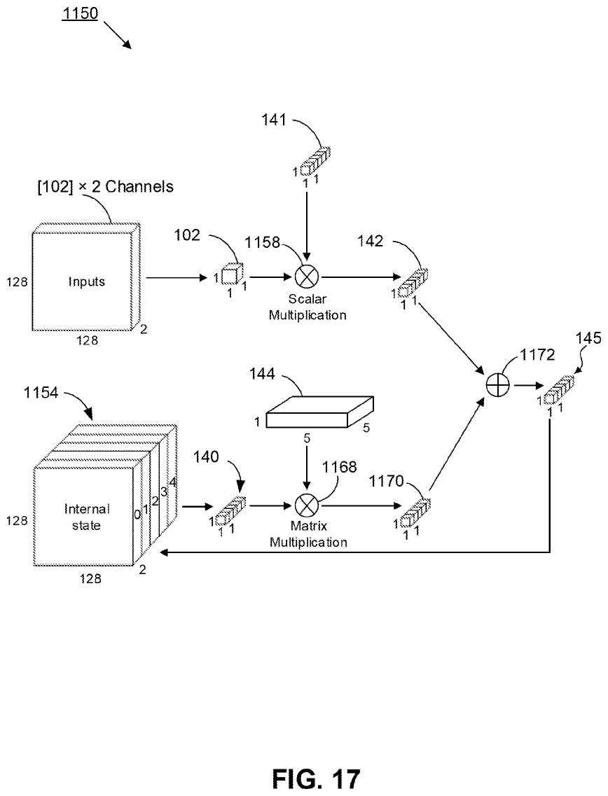

FIG. 17 illustrates an example method 1150 for performing recurrence and

updating the internal states along basis functions of the one or more temporal convolution layers in the recurrent mode in a multi-channel scenario, in accordance with an embodiment of the disclosure. FIG. 17 depicts a scenario for performing recurrence and updating the internal state of the one or more temporal convolution layers in the recurrent mode, when each time a new incoming temporal data sequence is received at the input interface 303. The update in the internal state corresponds to a change in the internal state representing a forward shifted temporal window for each layer and channel. The input interface 303 may receive each of the new incoming temporal data sequences in a sequence of time instances (timebins) at multiple channels of the input interface 303. For the ease of explanation and sake of the brevity of the present disclosure, a description for FIG. 17 will be provided with reference to one recurrent layer of the spatiotemporal neural network 500. As shown in FIG. 17, the internal state 1154 of the recurrent layer may be represented by the tensor that has dimensions of Input channels×Width×Height×Coefficients. In a non-limiting example, there are two input channels as shown in FIG. 17. Further, in the non-limiting example, each channel among the two channels may receive the data of an input size with a height and width of 128. Thus, the dimension of the received input data may correspond to 128×128×2 bits. Further, each channel among the two channels may receive the corresponding temporal data sequences as the input in a corresponding timebin 1156 of a plurality of coefficients 1166. Further, in the non-limiting example, a total of 5 coefficients are shown in FIG. 17 for the sake of brevity of the present disclosure.

The neural processor 320 may perform, for the corresponding timebins 1156 of the plurality of timebins 1166, a scalar multiplication 1158 of each of the new incoming temporal data sequences with the reference matrix 141 to determine the projected input 142. In parallel, the neural processor 320 also performs, for the corresponding timebins, a matrix multiplication of the reference matrix 144 with the current internal state 140 of the recurrent layer to generate a transformed internal state 1170 of the recurrent layer. Further, the current internal state 140 of the recurrent layer may also be referred to as the memory vector 140 as shown in FIGS. 13 and 15.

Once the transformed internal state 1170 of the recurrent layer is generated, then the neural processor 320 may update the internal state 140 of the recurrent layer by adding (1172) the transformed internal state 1170 of the recurrent layer with the projected input 142. As shown in FIG. 17, the updated internal state is denoted by the reference numeral 145. Further, when a new temporal data sequence is received in a second timebin, then the neural processor 320 may consider the updated internal state 145 as the current internal state of the recurrent layer for processing the new temporal data sequence that is received in the second timebin. This process of updating the internal state of the recurrent layer is repeated until each of the incoming temporal data sequences is processed for each timebin of the plurality of timebins.

Although, a description for FIG. 17 is provided with reference to the recurrent layer of the spatiotemporal neural network 500. However, similar operations as described herein with reference to FIG. 17 may be performed by the neural processor 320 for the other temporal convolution layers 2 through N of the spatiotemporal neural network 500 at each of the time instances where a new incoming temporal data sequence is received at the input interface 303.

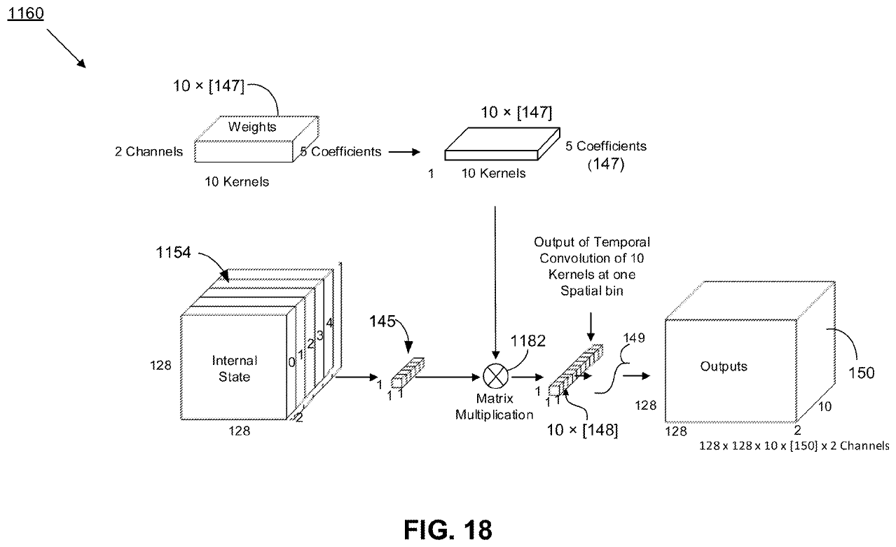

Referring now to FIG. 18 illustrates an example method 1160 for performing a non-separable feedforward operation in the multi-channel scenario, in accordance with an embodiment of the disclosure. As shown in FIG. 18, the internal state 140 of the temporal convolution layer 1 is represented by the tensor that has dimensions of Input channels×Width×Height×Coefficients. Each input channel among the two input channels as shown in FIG. 18 contains its own set of coefficients (internal state).

In the method 1160, the neural processor 320 may perform, for the coefficients of each input channel at each spatial pixel (145), a matrix multiplication 1182 with the plurality of temporal kernel coefficients 147 to generate scalar output values 148. In a non-limiting example, a group of 5 temporal kernel coefficients is used for performing the matrix multiplication 1182. Thereafter, in a non-limiting example as shown in FIG. 18, each of the matrix multiplication 1182 provides the scalar output value 148 at each spatial bin. Thereafter, one or more nonlinear activation functions 149 are applied on the corresponding scalar values 148 to generate output result 150 and the generated output result 150 is further passed to a next convolution layer of the spatiotemporal neural network 500.

Although, a description for FIG. 18 is provided with reference to a recurrent layer of the spatiotemporal neural network 500. However, the similar non-separable temporal convolution as shown using the method 1160 may be performed by the neural processor 320 in the recurrent mode for each connection associated with the corresponding neuron of the group of neurons among the plurality of neurons of the other recurrent layers of the spatiotemporal neural network 500. Also, the matrix multiplication 1182 may be performed by the neural processor 320 at each of the time instances when the internal state of the corresponding convolution layers is updated.

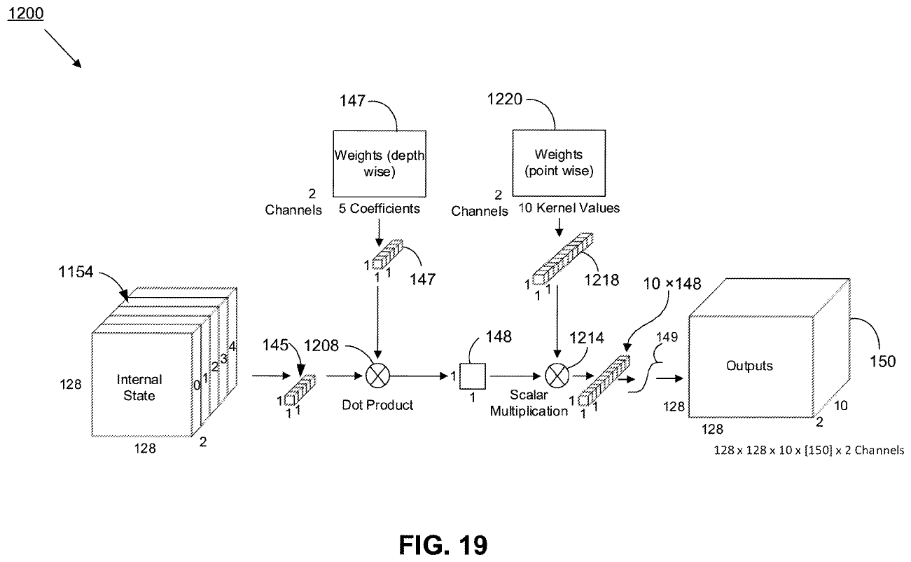

Referring now to FIG. 19 illustrates an example method 1200 for performing a separable feedforward operation in the multi-channel scenario, in accordance with an embodiment of the disclosure. For ease of explanation, the same internal state 140 as of FIGS. 17 and 18 are used in FIG. 19.

In the method 1200, at first, the neural processor 320 may perform, for the coefficients of each input channel at each spatial pixel (145), a dot product 1208 with a plurality of depth-wise temporal kernel coefficients 1204. As a result of the performed dot products, a plurality of scalar values may be generated. In a non-limiting example, as shown in FIG. 19, ne scalar value 148 as a result of the corresponding dot products is generated for each of the two input channels. Secondly, in the method 1200, the neural processor 320 may perform, for each input channel a scalar multiplication 1214 of the corresponding scalar values 148 that are generated as the result of the performed dot products 1208 with a plurality of point wise temporal kernel coefficients 1220 to generate output values scaled by multiple values. For example, as shown in FIG. 19, for the first input channel, the neural processor 320 performed the scalar multiplication 1214 of the corresponding scalar output value with a first group of point wise temporal kernel coefficients 1218 among the plurality of point wise temporal kernel coefficients 1220. Thereafter, in a non-limiting example as shown in FIG. 19, each of the scalar multiplication 1214 that is followed by the dot product operation 1208 provides an output result for each spatial bin. Thereafter, one or more nonlinear activation functions 149 are applied on the corresponding output result of the scalar multiplication 1214 followed by the dot product operation 1208 to generate the output result 150 for each spatial bin. The generated corresponding output result 150 is further passed to the next convolution layer of the spatiotemporal neural network 500.

Although, the description for FIG. 19 is provided with reference to a recurrent layer of the spatiotemporal neural network 500. However, the similar separable temporal convolution as shown using the method 1200 may be performed by the neural processor 320 in the recurrent mode for each connection associated with the corresponding neuron of the group of neurons among the plurality of neurons of the other recurrent layers of the spatiotemporal neural network 500.

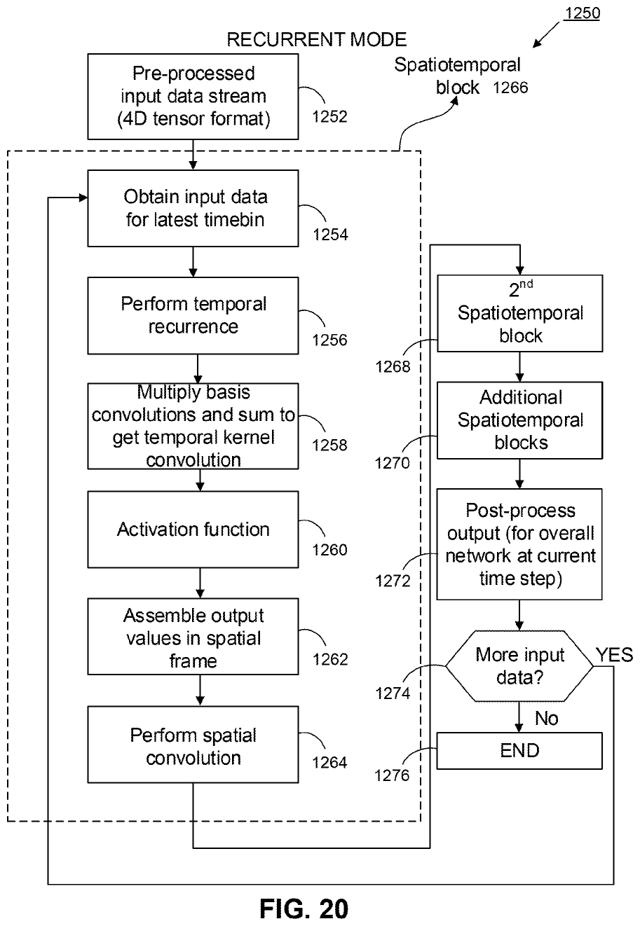

FIG. 20 is a flow chart of a method 1250 performed by the neural processor 320 for performing recurrent operations followed by spatial convolutions in the recurrent mode using one or more convolution layers of the spatiotemporal neural network 500, in accordance with an embodiment of the disclosure. The method 1250 (at step 1252), includes receiving a pre-processed input data stream at the input interface 303 of the neural network system 300. As an example, the neural processor 320 may read the pre-processed input data stream that is received at the input interface 303 of the neural network system 300. As described herein above with respect to FIG. 12, the received input data stream may comprise, typically, the 4D tensor data, generally read by the spatiotemporal neural network 500 as the stream of 3D tensor data. Since a detailed explanation related to the received input data stream is provided above herein with respect to FIG. 12, a detailed description of the same is omitted herein for the sake of brevity of the disclosure. The neural processor 320 may be configured to process the received input data stream for each combination of the channel interaction of the channels of the spatiotemporal neural network 500. Although, in one or more embodiments disclosed herein, the neural processor 320 processes one of the channels of the input data stream i.e., the 4D tensor data. However, the neural processor 320 may process each of the channels of the input data stream for each of the channel interactions in the spatiotemporal neural network 500.

The neural processor 320 processes the received input data stream through a first spatiotemporal block (ST-block) 1266 (surrounded by dashed box) followed by a 2nd ST-block 1268 and additional ST-block(s) 1270. It is to be noted that the first ST-block 1266, the second ST-block 1268, and the additional” ST-block(s) 1270 as shown in FIG. 20 are for illustration purposes only and may not be construed as limiting in nature for a person skilled in the art.

In an embodiment, the operations in the first ST-block 1266 comprises one temporal convolution operation followed by one spatial convolution. In some embodiments, the first ST-block 1266 may contain more than one consecutive temporal convolution operation and/or more than one consecutive spatial convolution. The temporal convolution step is applied separately to each timebin of each input image frame of the input data stream. The spatial convolution step is applied separately to each spatial bin of each input image frame of the input data stream. The neural processor 320 may perform the temporal convolution at a particular time step at each of the one or more temporal convolution layers 1 through N sequentially or in parallel.

The method steps 1254 to 1264 of the method 1250, corresponds to operations performed by the neural processor 320 in the first ST block 1266. At step 1254, the neural processor 320 obtains, from the received input data stream, first input data as the first temporal data sequence at the first time instance. At step 1256, the neural processor 320 performs temporal recurrence on the obtained first temporal data sequence to update the internal state of the one or more temporal convolution layers 1 through N of the spatiotemporal neural network 500. At step 1258, the neural processor 320 performs multiply basis convolutions of the updated internal states with one or more temporal kernels and sum them to generate one or more temporal convolution output values. As an example, for performing the multiply basis convolutions of the updated internal states with one or more temporal kernels, the neural processor 320 transforms, for the first temporal data sequence, the memory vector 140 based on the matrix multiplication of the reference matrix 144 with the memory vector 140 and thereby generates the updated memory vector 145 (i.e., updated internal state) based on the transformed memory vector and the projected input 142. Thereafter, the neural processor 320 performs, for each connection associated with a corresponding neuron of a group of neurons among the plurality of neurons at each of the temporal convolution layers 1 through N, a dot product of the updated memory vector 145 with the plurality of temporal kernel coefficients.

At step 1260, the neural processor 320 applies the one or more activation functions 149 on the one or more temporal convolution output values to convert the one or more temporal convolution output values into one or more nonlinear temporal convolution output values. In a non-limiting example, the one or more activation functions 149 may include ReLU or a sigmoid function. At step 1262, the neural processor 320 assembles the one or more nonlinear temporal convolution output values at their spatial bin locations in a spatial image frame. At step 1264, the neural processor 320 perform a spatial convolution operation on the one or more nonlinear temporal convolution output values in the spatial image frame using the plurality of spatial kernel coefficients. The neural processor 320 may select a plurality of parameters including a desired value of kernel size, stride, padding, a subsequent activation function, etc., and may perform, using any spatial convolution methods known in the art, the spatial convolution based on the selected plurality of parameters.

When the operations steps 1252 to 1264 of the first ST-block 1266 are performed for the first temporal data sequence of the temporal data sequences at the first time instance, then output data from the first ST-block 1266 is passed onto the second ST-block 1268. Further, after completion of the processing at the ST-block 1270, the neural processor 320, at step 1272, performs post-processing of the output data for overall spatiotemporal neural network 500 for the current time instance.

In addition, to take advantage of parallel processing hardware, the first ST-block 1266 may be configured to fetch data from the next time instance (if available) while subsequent ST-blocks 1268 and 1270 may still process the output data from the current time instance. As an example, at step 1274, the neural processor 320, may determine whether more input data is available at the input interface 303 after completing the processing at the first ST-block 1266. If at step 1274, it is determined that more input data is available, then the neural processor 320 may obtain the next available temporal data sequence at step 1254 of the first ST-block 1266 for further processing. The same applies to other ST-blocks 1268 and 1270 of the spatiotemporal neural network 500. This method of processing different time instances at successive ST-blocks may be referred to as pipelining without any deviation from the scope of the present disclosure.

Further, if at step 1274, it is determined that no more input data is available, the method 1250 comes to an end at step 1276.

It is to be noted that the flow of the temporal and spatial convolution operations in the form of sequenced ST-blocks is merely exemplary. Therefore, in some embodiments, the flow of the temporal and spatial convolution operations may be represented in a sequence that is different from the ST-blocks sequence.

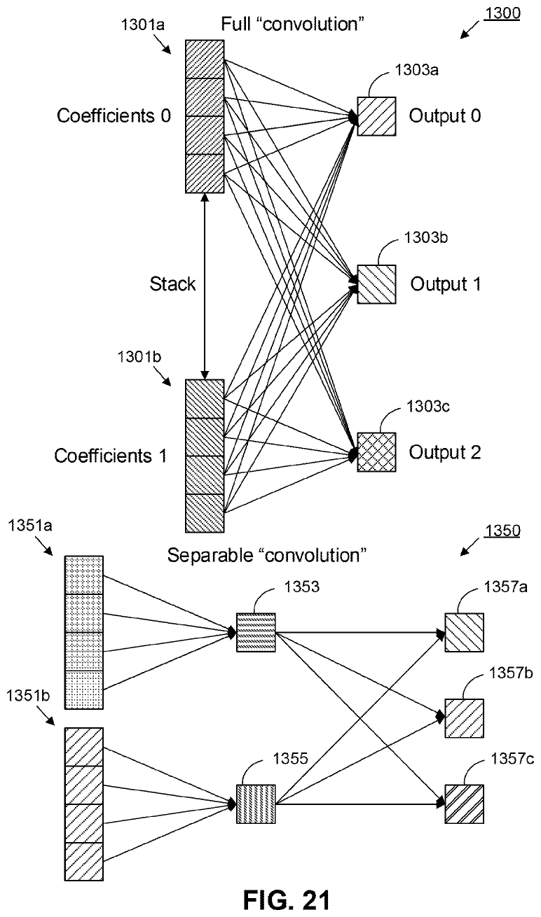

FIG. 21 illustrates another exemplary scenario depicting methods for performing full feedforward projections and separable feedforward projections in the recurrent mode in the multi-channel scenario, in accordance with an embodiment of the disclosure. In the method 1300, the neural processor 320 may perform, for each input-output channel interaction, a matrix multiplication of corresponding internal states of the one or more temporal convolution layers 1 through N with the plurality of temporal kernel coefficients to generate temporal convolution output values. For example, as shown in FIG. 21, a plurality of groups of temporal kernel coefficients may be used for performing the matrix multiplication by the neural processor 320. In a non-limiting example, a first group 1301a of 4 temporal kernel coefficients 0 is used for performing the matrix multiplication and generating a first plurality of temporal output values corresponding to each of the output channels 0, 1, and 2. Similarly, a second group 1301b of 4 temporal kernel coefficients 1 is used for performing the matrix multiplication and generating a second plurality of temporal output values corresponding to each of the output channels 0, 1, and 2. Each of the generated plurality of temporal output values may be further passed to the next available convolution layer of the spatiotemporal neural network 500.

In the method 1350, at first, the neural processor 320 may perform, for each input-output channel interaction, a dot product of each of the corresponding internal states of one or more temporal convolution layers 1 through N with a plurality of groups of depth wise temporal kernel coefficients to generate a plurality of scalar values. In a non-limiting example, as shown in FIG. 21, a first group 1351a of 4 depth wise temporal kernel coefficients is used for performing the dot product and generating a scalar value 1353. Similarly, a second group 1351b of another 4 depth-wise temporal kernel coefficients are used for performing the dot product and generating a scalar value 1355. Secondly, in the method 1350, the neural processor 320 may perform, for each input-output channel interaction, a scalar multiplication of the corresponding scalar values that are generated as the result of the performed dot products with a plurality of groups of point wise temporal kernel coefficients to generate the temporal convolution output values. For example, as shown in FIG. 21, the scalar value 1353 may be used for performing the scalar multiplication with a first group of point wise temporal kernel coefficients. Similarly, the scalar value 1355 may be used for performing the scalar multiplication with a second group of point wise temporal kernel coefficients. Each of the generated plurality of temporal output values 1357a, 1357b, and 1357c as the result of the performed scalar multiplication followed by the performed dot product may be further passed to the next available convolution layer of the spatiotemporal neural network 500.

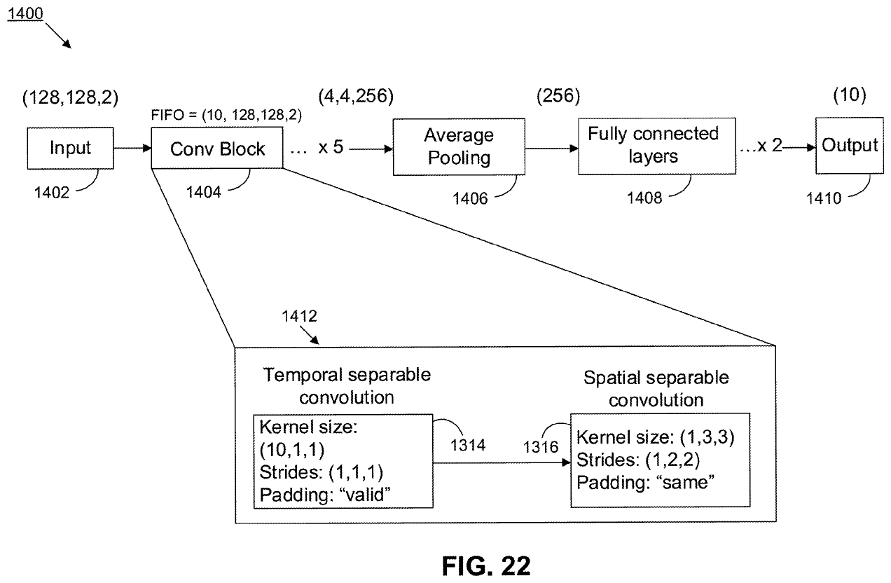

FIG. 22 illustrates an exemplary scenario depicting an entire network built from a stack of STBlocks consisting of buffered temporal layers, interfacing with the DVS128 dataset in accordance with the method disclosed herein. For performing the spatiotemporal convolution 5 temporal convolution layers and 5 spatial convolution layers are used and an average pooling 1406 and 2 fully connected layers 1408 are attached at the end. This results in a total autoregressive time window of length 90 ms×5=450 ms. In addition, a 70 ms majority vote filter may also be attached to the network output to smooth out the predictions. This setup allows to achieve an accuracy of 100% on the DVS128 dataset as compared to other neural network architectures which achieve much lower accuracies with almost 100 times more parameters and latencies up to 1500 ms.

According to yet another embodiment of the disclosure, the buffer mode of the spatiotemporal neural network 400 is memory efficient as each of the temporal convolution layers keeps a size of the FIFO buffer same as that of the temporal kernels size. However, in high-end applications, a larger temporal kernel size is required in comparison to that of the temporal kernel size used in the buffer mode. In such cases, the recurrent mode can be used for applications where a very large temporal kernel size is required to process the input data.

Accordingly, in an embodiment of the present disclosure, the neural processor 320 perform training of the spatiotemporal neural network 400 i.e., a non-recurrent neural network in a convolution mode (i.e., in the buffer mode) based on sequential data received by the input interface 303. Further, the neural processor 320 determines the plurality of temporal kernel coefficients upon the training of the spatiotemporal neural network 400. The plurality of temporal kernel coefficients corresponds to coefficients that are derived based on the one or more basis functions such as the orthogonal polynomials. Further, the neural processor 320 configures the spatiotemporal neural network 500 (i.e., the recurrent neural network) based on the determined plurality of temporal kernel coefficients. Also, the neural processor 320 further configures the spatiotemporal neural network 500 based on one or more reference matrices (the projection vector 141, state matrix 144) that are defined based on application of the set of basis functions such as the orthogonal polynomials. In particular, a core procedure to configure the recurrent neural network is to convert the convolution operation of the buffer convolution mode to basis function coefficient space. To convert the convolution operation of the buffer convolution mode into the basis function coefficient space, the neural processor 320 inserts the polynomial representation of the temporal kernels into the convolution operation of the buffer mode and thus arrives at the following expressions shown below in equation (4):

$$u ( d , i , j , t ) = {\sum }_{c} {\sum }_{n , m = 0 , 0}^{N , M} h ( c , d , m {τ}_{b} ) I ( c , i , j , t - m {τ}_{b} ) = {\sum }_{c} {\sum }_{n , m = 0 , 0}^{N , M} {a}_{n} ( c , d ) {𝒫}_{n} ( - 1 + 2 \frac{m}{M - 1} ) I ( c , i , j , t - m {τ}_{b} ) = {\sum }_{c} {\sum }_{n = 0}^{N} {a}_{n} ( c , d ) {β}_{n} ( c , i , j , t ) = {\sum }_{c} a ( c , d ) \cdot β ( c , i , j , t ) , … \qquad ( 4 )$$

Where, β corresponds to a projection of the inputs within the time window [t−T, t] onto the orthogonal polynomial basis functions. Further, as can be seen from the above shown equation (4), the convolution operation in the time domain becomes a dot product in the coefficient domain. Furthermore, the internal state β is constantly maintained and updated with access to only its current state and a new input.

Once the spatiotemporal neural network 400 is configured based on the plurality of temporal kernel coefficients, the neural processor 320 is configured to perform inference using the configured spatiotemporal neural network 500. Thus, the temporal convolution layers of the spatiotemporal neural network 500 is configured to perform inference for an efficient online inference automatically. The configuration of the spatiotemporal neural network 500 using the plurality of temporal kernel coefficients is especially useful for mobile devices and edge computing for performing efficient online inference over spatiotemporal data streams. Also, the configuration of the spatiotemporal neural network 500 using the plurality of temporal kernel coefficients helps in facilitating a transition of the computation process for the system 300 from the cloud to the edge devices.

The methods, systems, and apparatus discussed above are merely exemplary. Various configurations may omit, substitute, or add various procedures or components as appropriate. For instance, in alternative configurations, the methods may be performed in an order different from that described, and various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur in a different order than shown in any flowchart. For example, two blocks shown in succession may be executed substantially concurrently or the blocks may sometimes be executed in the reverse order, depending upon the functionality/acts involved. Additionally, or alternatively, not all of the blocks shown in any flowchart need to be performed and/or executed. For example, if a given flowchart has seven blocks containing functions/acts, it may be the case that only five of the seven blocks are performed and/or executed. In this example, any of five of the seven blocks may be performed and/or executed.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having been provided with the description and illustration of the present application, one skilled in the art may envision variations, modifications, and alternate embodiments falling within the general inventive concept discussed in this application that does not depart from the scope of the following claims.

We claim:

1. A neural network system, comprising:
an input interface configured to receive sequential data that includes temporal data sequences;
a memory configured to store a plurality of group of first temporal kernel values, a first plurality of FIFO buffers corresponding to a current temporal layer, and implement a neural network that includes a first plurality of neurons for the current temporal layer, a corresponding group among the plurality of groups of the first temporal kernel values is associated with each connection of a corresponding neuron of the first plurality of neurons;
a processor configured to:
allocate the first plurality of FIFO buffers to a first group of neurons among the first plurality of neurons;
receive, from corresponding temporal data sequences over a first time window, a first temporal sequence of the corresponding temporal data sequences into the first plurality of FIFO buffers allocated to the first group of neurons;
perform, for each connection of a corresponding neuron of the first group of neurons, a first dot product of the first temporal sequence of the corresponding temporal data sequences within a corresponding FIFO buffer of first plurality of FIFO buffers with a corresponding temporal kernel value among the corresponding group of the first temporal kernel values, wherein the corresponding temporal kernel values is associated with a corresponding connection of the corresponding neuron of the first group of neurons;
determine a corresponding potential value for the corresponding neurons of the first group of neurons based on the performed first dot product; and
generate a first output response based on the determined corresponding potential values.

2. The neural network system of claim 1, wherein the memory is further configured to store a plurality of groups of second temporal kernel values for a next temporal layer and a second plurality of FIFO buffers corresponding to the next temporal layer,
the neural network includes a second plurality of neurons for the next temporal layer, and
the processor is further configured to:
allocate the second plurality of FIFO buffers to a group of neurons among the second plurality of neurons;
receive, from corresponding temporal data sequences over a second time window, a second temporal sequence of the corresponding temporal data sequences into the second plurality of FIFO buffers allocated to the group of neurons into the second plurality of FIFO buffers; and
perform, for each connection of a corresponding neuron of the group of neurons among the second plurality of neurons, a second dot product of the second temporal sequence of the corresponding temporal data sequences within a corresponding FIFO buffer of the second plurality of FIFO buffers with a corresponding temporal kernel value among the corresponding group of the second temporal kernel values.

3. The neural network system of claim 1, wherein the processor is further configured to:
determine, based on the performed second dot product, a corresponding potential value for the corresponding neurons of the group of neurons among the second plurality of neurons; and
generate a second output response based on the determined corresponding potential values associated with the corresponding neurons of the group of neurons among the second plurality of neurons.

4. The neural network system of claim 1, wherein, to determine the corresponding potential value for the corresponding neuron of the first group of neurons among the first plurality of neurons, the processor is configured to:
assemble, for each connection of the corresponding neuron of the first group of neurons among the first plurality of neurons, each of a corresponding output value of the performed first dot product of the first temporal sequence within the corresponding FIFO buffer of first plurality of FIFO buffers with the corresponding temporal kernel value among the corresponding group of the first temporal kernel values; and
determine, based on the assembled corresponding output values of the performed first dot product, the corresponding potential value for the corresponding neurons of the group of neurons among the first plurality of neurons.

5. The neural network system of claim 1, wherein, to determine the corresponding potential value for the corresponding neuron of the first group of neurons among the first plurality of neurons, the processor is further configured to:
apply one or more nonlinear activation functions on the corresponding results of the first dot product; and
determine, based on a result of the application of the one or more nonlinear activation functions on the corresponding results of the dot product, the corresponding potential value for the corresponding neurons of the group of neurons among the first plurality of neurons.

6. The neural network system of claim 1, wherein the processor is further configured to perform each of the first dot product at the current temporal layer and the second dot product at the next temporal layer, simultaneously in parallel with respect to each other.

7. The neural network system of claim 1, wherein
the memory is further configured to store a plurality of group of spatial kernel values,
the neural network includes a third plurality of neurons for a spatial layer,
the spatial layer is followed by one of the current temporal layer or the next temporal layer,
the processor is further configured to:
receive corresponding input data from the corresponding neuron of the group of neurons of one of the current temporal layer or the next temporal layer; and
perform, for each connection of a corresponding neuron of a group of neurons among the third plurality of neurons, a third dot product of the corresponding input data with a corresponding spatial kernel value among a corresponding group of the spatial kernel values.

8. The neural network system of claim 1, wherein the processor is further configured to:
recognize, based on a selection of the corresponding group of the first temporal kernel values, a change in a response pattern of one or more neurons in the group of neurons among the first plurality of neurons over a time period; and
update the first temporal kernel values based on the recognized change in the response pattern.

9. The neural network system of claim 1, wherein
the input interface includes a plurality of input channels, and
each input channel of the plurality of input channels is configured to receive the sequential data.

10. The neural network system of claim 9, wherein
the plurality of group of first temporal kernel values and the first plurality of FIFO buffers corresponds to a first input channel of the plurality of input channels, and
the processor is further configured to receive, at the first input channel, the first temporal sequence of the corresponding temporal data sequences into the first plurality of FIFO buffers.

11. The neural network system of claim 10, wherein
the memory is further configured to:
store, for a second input channel of the plurality of input channels, a plurality of group of second temporal kernel values and a second plurality of FIFO buffers corresponding to the current temporal layer; and
store, for a third input channel of the plurality of input channels, a plurality of group of third temporal kernel values and a third plurality of FIFO buffers corresponding to the current temporal layer.

12. The neural network system of claim 10, wherein the processor is further configured to:
allocate the second plurality of FIFO buffers to a second group of neurons among the first plurality of neurons and the third plurality of FIFO buffers to a third group of neurons among the first plurality of neurons;
receive, from corresponding temporal data sequences over the first time window, a second temporal sequence of the corresponding temporal data sequences into the second plurality of FIFO buffers and a third temporal sequence of the corresponding temporal data sequences into the third plurality of FIFO buffers; and
perform, simultaneously in parallel for each connection of a corresponding neuron of the second group of neurons and the third group of neurons, a second dot product of the second temporal portion within the second plurality of FIFO buffers with the plurality of group of second temporal kernel values and a third dot product of the third temporal portion within the third plurality of FIFO buffers with the plurality of group of third temporal kernel values.

13. The neural network system of claim 12, wherein the processor is further configured to:
assemble, for each connection of the corresponding neuron of the group of neurons among the first plurality of neurons, each of a corresponding output value of the performed dot products corresponding to the first input channel, the second input channel, and the third input channel; and
generate the output response based on the assembled corresponding output values of the performed dot products.

14. A neural network system, comprising:
an input interface configured to receive sequential data that includes temporal data sequences;
a memory configured to implement a neural network and store a plurality of temporal kernel coefficients, a reference matrix to update a memory vector, wherein the neural network is configured to perform a temporal convolution using one or more temporal layers, a corresponding temporal layer of the one or more temporal layers includes of a plurality of neurons;
for corresponding temporal layer of the one or more temporal layers, at least one processor configured to:
receive a first temporal data sequence of the temporal data sequences at a first time instance;
transform, for the first temporal data sequence, the memory vector based on a matrix multiplication of the reference matrix with the memory vector;
generate an updated memory vector based on the transformed memory vector and a projected temporal input that is generated based on the first temporal data sequence;
perform, for each connection associated with a corresponding neuron of a group of neurons among the plurality of neurons, a dot product of the generated memory vector with the plurality of temporal kernel coefficients;
determine a corresponding potential value for the corresponding neurons based on the performed dot product; and
generate an output response based on the determined corresponding potential values.

15. The neural network system of claim 14,
wherein the memory is further configured to store a projection vector for each of the temporal data sequences, wherein the projection vector is same for each of the temporal data sequences, and
wherein, to generate the updated memory vector, the at least one processor is configured to:
project the projection vector on the received first temporal data sequence;
determine the projected temporal input based on the projection of the projection vector on the first temporal data sequence; and
generate the updated memory vector based on an addition of the transformed memory vector and the determined projected temporal input.

16. The neural network system of claim 14, wherein the at least one processor is further configured to:
receive a second temporal data sequence of the temporal data sequences at a second time instance;
transform the updated memory vector based on a matrix multiplication of the reference matrix with the updated memory vector, repetitively;
generate a new memory vector based on an addition of the transformed updated memory vector with the determined projected temporal input; and
perform, for the corresponding neuron of the group of neurons, a dot product of the newly generated memory vector with the plurality of temporal kernel coefficients.

17. The neural network system of claim 16, wherein the at least one processor is further configured to transform the newly generated memory vector at a consecutive time instance at which a new temporal data sequence of the temporal data sequences is received.

18. The neural network system of claim 16, wherein the at least one processor is further configured to repeatedly generate the new memory vector until the updated memory vector is transformed for each of the temporal data sequences.

19. The neural network system of claim 14, wherein, to determine the corresponding potential value for the corresponding neurons, the at least one processor is further configured to:
apply one or more activation functions on the corresponding result of the dot products; and
determine the corresponding potential value for the corresponding neurons based on a result of the application of the one or more activation functions on the corresponding result of the dot products.

20. The neural network system of claim 14, wherein the at least one processor is further configured to determine the projection vector based on one or more basis functions.

21. The neural network system of claim 14, wherein the at least one processor is further configured to store the updated memory vector in the memory at each consecutive time instance when the new memory vector is generated.

22. The neural network system of claim 14, wherein
the input interface includes a plurality of input channels, and
the input interface is further configured to receive the data sequence at each input channel of the plurality of input channels.

23. The neural network system of claim 22,
wherein a first group of temporal kernel coefficients among the plurality of temporal kernel coefficients corresponds to a first input channel of the plurality of input channels, and
wherein, for corresponding temporal layer of the one or more temporal layers, the processor is further configured to receive the first temporal data sequence of the temporal data sequences at the first input channel.

24. The neural network system of claim 23,
wherein a second group of temporal kernel coefficients among the plurality of temporal kernel coefficients corresponds to a second input channel of the plurality of input channels,
wherein a third group of temporal kernel coefficients among the plurality of temporal kernel coefficients corresponds to a third input channel of the plurality of input channels, and
wherein, for corresponding temporal layer of the one or more temporal layers, the processor is further configured to:
receive the first temporal data sequence of the temporal data sequences at each of the second input channel and the third input channel at the first time instance;
perform, for each connection associated with a corresponding neuron of a group of neurons among the plurality of neurons, a first dot product of the generated memory vector with the first group of temporal kernel coefficients, a second dot product of the generated memory vector with the second group of temporal kernel coefficients, and a third dot product of the generated memory vector with the third group of temporal kernel coefficients;
apply the one or more activation functions on each of the corresponding results of the first dot product, the second dot product, and the third dot product; and
determine the corresponding potential value for the corresponding neurons based on a result of the application of the one or more activation functions on the corresponding results of the first dot product, the second dot product, and the third dot product.

25. A neural network system, comprising:
an input interface configured to receive sequential data that includes temporal data sequences;
a memory configured to implement a neural network and store one or more temporal kernel coefficients for a temporal layer, and a projection vector for each of the temporal data sequences, a reference matrix to update a memory vector, wherein the neural network includes a spatial layer and a temporal layer, the temporal layer includes a first plurality of neurons;
for the temporal layer, at least one processor configured to:
receive a first data sequence of the temporal data sequences at a first time instance;
project the projection vector onto the received first data sequence;
determine a projected temporal input based on the projection of the projection vector onto the first input data sequence;
transform the memory vector based on a matrix multiplication of the reference matrix with the memory vector;
generate an updated memory vector based on an addition of the transformed memory vector with the determined projected temporal input;
perform, for a corresponding neuron of a group of neurons among the first plurality of neurons, a dot product of the generated memory vector with the one or more temporal kernel coefficients;
determine a corresponding potential value for the corresponding neurons of the group of neurons based on the performed dot product; and
generate an output response based on the determined corresponding potential values.

26. A neural network system, comprising:
an input interface configured to receive sequential data;
a memory configured to implement a non-recurrent neural network; and
one or more neural processors communicatively coupled with the memory, wherein the one or more neural processors are configured to:
train the non-recurrent neural network in a convolution mode based on the received sequential data;
determine a plurality of temporal kernel coefficients upon the training of the non-recurrent neural network;
configure a recurrent neural network based on the determined plurality of temporal kernel coefficients; and
perform inference using the configured recurrent neural network.

27. The system of claim 26, wherein the determined plurality of temporal kernel coefficients corresponds to coefficients that are derived based on a set of basis functions.

28. The system of claim 26, wherein the recurrent neural network is further configured based on one or more reference matrices that are defined based on a set of basis functions.

29. A method, comprising:
in a neural network system that includes an input interface, a memory, and a processor:
receiving, by the input interface, sequential data that includes temporal data sequences;
storing, in the memory, a plurality of group of first temporal kernel values, a first plurality of FIFO buffers corresponding to a current temporal layer;
implementing, in the memory, a neural network that includes a first plurality of neurons for the current temporal layer, a corresponding group among the plurality of groups of the first temporal kernel values is associated with each connection of a corresponding neuron of the first plurality of neurons;
allocating, by the processor, the first plurality of FIFO buffers to a first group of neurons among the first plurality of neurons;
receiving, by the processor from corresponding temporal data sequences over a first time window, a first temporal sequence of the corresponding temporal data sequences into the first plurality of FIFO buffers allocated to the first group of neurons;
performing, by the processor for each connection of a corresponding neuron of the first group of neurons, a first dot product of the first temporal sequence of the corresponding temporal data sequences within a corresponding FIFO buffer of first plurality of FIFO buffers with a corresponding temporal kernel value among the corresponding group of the first temporal kernel values, wherein the corresponding temporal kernel values is associated with a corresponding connection of the corresponding neuron of the first group of neurons;
determining, by the processor, a corresponding potential value for the corresponding neurons of the first group of neurons based on the performed first dot product; and
generating, by the processor, a first output response based on the determined corresponding potential values.

30. The method of claim 29, further comprising:
storing, in the memory, a plurality of groups of second temporal kernel values for a next temporal layer and a second plurality of FIFO buffers corresponding to the next temporal layer, wherein the neural network includes a second plurality of neurons for the next temporal layer;
allocating, by the processor, the second plurality of FIFO buffers to a group of neurons among the second plurality of neurons;
receiving, by the processor from corresponding temporal data sequences over a second time window, a second temporal sequence of the corresponding temporal data sequences into the second plurality of FIFO buffers allocated to the group of neurons into the second plurality of FIFO buffers; and
performing, by the processor for each connection of a corresponding neuron of the group of neurons among the second plurality of neurons, a second dot product of the second temporal sequence of the corresponding temporal data sequences within a corresponding FIFO buffer of the second plurality of FIFO buffers with a corresponding temporal kernel value among the corresponding group of the second temporal kernel values.

31. The method of claim 29, further comprising:
determining, by the processor based on the performed second dot product, a corresponding potential value for the corresponding neurons of the group of neurons among the second plurality of neurons; and
generating, by the processor, a second output response based on the determined corresponding potential values associated with the corresponding neurons of the group of neurons among the second plurality of neurons.

32. The method of claim 29, wherein, for determining the corresponding potential value for the corresponding neuron of the first group of neurons among the first plurality of neurons, the method comprises:
assembling, by the processor for each connection of the corresponding neuron of the first group of neurons among the first plurality of neurons, each of a corresponding output value of the performed first dot product of the first temporal sequence within the corresponding FIFO buffer of first plurality of FIFO buffers with the corresponding temporal kernel value among the corresponding group of the first temporal kernel values; and
determining, by the processor based on the assembled corresponding output values of the performed first dot product, the corresponding potential value for the corresponding neurons of the group of neurons among the first plurality of neurons.

33. The method of claim 29, wherein, for determining the corresponding potential value for the corresponding neuron of the first group of neurons among the first plurality of neurons, the method comprises:
applying, by the processor, one or more nonlinear activation functions on the corresponding results of the first dot product; and
determining, by the processor based on a result of the application of the one or more nonlinear activation functions on the corresponding results of the dot product, the corresponding potential value for the corresponding neurons of the group of neurons among the first plurality of neurons.

34. The method of claim 29, further comprising:
performing, by the processor, each of the first dot product at the current temporal layer and the second dot product at the next temporal layer, simultaneously in parallel with respect to each other.

35. The method of claim 29, further comprising:
storing, in the memory, a plurality of group of spatial kernel values, wherein the neural network includes a third plurality of neurons for a spatial layer, and the spatial layer is followed by one of the current temporal layer or the next temporal layer;
receiving, by the processor, corresponding input data from the corresponding neuron of the group of neurons of one of the current temporal layer or the next temporal layer; and
performing, by the processor for each connection of a corresponding neuron of a group of neurons among the third plurality of neurons, a third dot product of the corresponding input data with a corresponding spatial kernel value among a corresponding group of the spatial kernel values.

36. The method of claim 29, further comprising:
recognizing, by the processor based on a selection of the corresponding group of the first temporal kernel values, a change in a response pattern of one or more neurons in the group of neurons among the first plurality of neurons over a time period; and
updating, by the processor, the first temporal kernel values based on the recognized change in the response pattern.

37. The method of claim 29, wherein
the input interface includes a plurality of input channels, and
each input channel of the plurality of input channels receives the sequential data.

38. The method of claim 37, wherein
the plurality of group of first temporal kernel values and the first plurality of FIFO buffers corresponds to a first input channel of the plurality of input channels, and
the method further comprises receiving, by the processor at the first input channel, the first temporal sequence of the corresponding temporal data sequences into the first plurality of FIFO buffers.

39. The method of claim 38, further comprising:
storing, in the memory for a second input channel of the plurality of input channels, a plurality of group of second temporal kernel values and a second plurality of FIFO buffers corresponding to the current temporal layer; and
storing, in the memory for a third input channel of the plurality of input channels, a plurality of group of third temporal kernel values and a third plurality of FIFO buffers corresponding to the current temporal layer.

40. The method of claim 38, further comprising:
allocating, by the processor, the second plurality of FIFO buffers to a second group of neurons among the first plurality of neurons and the third plurality of FIFO buffers to a third group of neurons among the first plurality of neurons;
receiving, by the processor from corresponding temporal data sequences over the first time window, a second temporal sequence of the corresponding temporal data sequences into the second plurality of FIFO buffers and a third temporal sequence of the corresponding temporal data sequences into the third plurality of FIFO buffers; and
performing, by the processor simultaneously in parallel for each connection of a corresponding neuron of the second group of neurons and the third group of neurons, a second dot product of the second temporal portion within the second plurality of FIFO buffers with the plurality of group of second temporal kernel values and a third dot product of the third temporal portion within the third plurality of FIFO buffers with the plurality of group of third temporal kernel values.

41. The method of claim 40, further comprising:
assembling, by the processor for each connection of the corresponding neuron of the group of neurons among the first plurality of neurons, each of a corresponding output value of the performed dot products corresponding to the first input channel, the second input channel, and the third input channel; and
generating, by the processor, the output response based on the assembled corresponding output values of the performed dot products.

42. A method, comprising:
in a neural network system that includes an input interface, a memory, and at least one processor:
receiving, by the input interface, sequential data that includes temporal data sequences;
implementing, in the memory, a neural network;
storing, in the memory, a plurality of temporal kernel coefficients, a reference matrix to update a memory vector, wherein the neural network performs a temporal convolution using one or more temporal layers, a corresponding temporal layer of the one or more temporal layers includes of a plurality of neurons; and
for corresponding temporal layer of the one or more temporal layers, the method further comprising:
receiving, by the at least one processor, a first temporal data sequence of the temporal data sequences at a first time instance;
transforming, by the at least one processor for the first temporal data sequence, the memory vector based on a matrix multiplication of the reference matrix with the memory vector;
generating, by the at least one processor, an updated memory vector based on the transformed memory vector and a projected temporal input that is generated based on the first temporal data sequence;
performing, by the at least one processor for each connection associated with a corresponding neuron of a group of neurons among the plurality of neurons, a dot product of the generated memory vector with the plurality of temporal kernel coefficients;
determining, by the at least one processor, a corresponding potential value for the corresponding neurons based on the performed dot product; and
generating, by the at least one processor, an output response based on the determined corresponding potential values.

43. The method of claim 42, further comprising:
storing, in the memory, a projection vector for each of the temporal data sequences, wherein the projection vector is same for each of the temporal data sequences, and
wherein, for generating the updated memory vector, the method further comprises:
projecting, by the at least one processor, the projection vector on the received first temporal data sequence;
determining, by the at least one processor, the projected temporal input based on the projection of the projection vector on the first temporal data sequence; and
generating, by the at least one processor, the updated memory vector based on an addition of the transformed memory vector and the determined projected temporal input.

44. The method of claim 42, further comprising:
receiving, by the at least one processor, a second temporal data sequence of the temporal data sequences at a second time instance;
transforming, by the at least one processor, the updated memory vector based on a matrix multiplication of the reference matrix with the updated memory vector, repetitively;
generating, by the at least one processor, a new memory vector based on an addition of the transformed updated memory vector with the determined projected temporal input; and
performing, by the at least one processor for the corresponding neuron of the group of neurons, a dot product of the newly generated memory vector with the plurality of temporal kernel coefficients.

45. The method of claim 44, further comprising:
transforming, by the at least one processor, the newly generated memory vector at a consecutive time instance at which a new temporal data sequence of the temporal data sequences is received.

46. The method of claim 44, further comprising:
repeatedly generating, by the at least one processor, the new memory vector until the updated memory vector is transformed for each of the temporal data sequences.

47. The method of claim 42, wherein, for determining the corresponding potential value for the corresponding neurons, the method further comprises:
applying, by the at least one processor, one or more activation functions on the corresponding result of the dot products; and
determining, by the at least one processor, the corresponding potential value for the corresponding neurons based on a result of the application of the one or more activation functions on the corresponding result of the dot products.

48. The method of claim 42, further comprising:
determining, by the at least one processor, the projection vector based on one or more basis functions.

49. The method of claim 42, further comprising:
storing, by the at least one processor, the updated memory vector in the memory at each consecutive time instance when the new memory vector is generated.

50. The method of claim 42, wherein
the input interface includes a plurality of input channels, and
the input interface receives the data sequence at each input channel of the plurality of input channels.

51. The method of claim 50,
wherein a first group of temporal kernel coefficients among the plurality of temporal kernel coefficients corresponds to a first input channel of the plurality of input channels, and
wherein, for corresponding temporal layer of the one or more temporal layers, the method further comprises receiving, by the at least one processor, the first temporal data sequence of the temporal data sequences at the first input channel.

52. The method of claim 51,
wherein a second group of temporal kernel coefficients among the plurality of temporal kernel coefficients corresponds to a second input channel of the plurality of input channels,
wherein a third group of temporal kernel coefficients among the plurality of temporal kernel coefficients corresponds to a third input channel of the plurality of input channels, and
wherein, for corresponding temporal layer of the one or more temporal layers, the method further comprises:
receiving, by the at least one processor, the first temporal data sequence of the temporal data sequences at each of the second input channel and the third input channel at the first time instance;
performing, by the at least one processor for each connection associated with a corresponding neuron of a group of neurons among the plurality of neurons, a first dot product of the generated memory vector with the first group of temporal kernel coefficients, a second dot product of the generated memory vector with the second group of temporal kernel coefficients, and a third dot product of the generated memory vector with the third group of temporal kernel coefficients;
applying, by the at least one processor, the one or more activation functions on each of the corresponding results of the first dot product, the second dot product, and the third dot product; and
determining, by the at least one processor, the corresponding potential value for the corresponding neurons based on a result of the application of the one or more activation functions on the corresponding results of the first dot product, the second dot product, and the third dot product.

53. A method, comprising:
in a neural network system that includes an input interface, a memory, and at least one processor:
receiving, by the input interface, sequential data that includes temporal data sequences;
implementing, in the memory, a neural network,
storing, in the memory, one or more temporal kernel coefficients for a temporal layer, and a projection vector for each of the temporal data sequences, a reference matrix to update a memory vector, wherein the neural network includes a spatial layer and a temporal layer, the temporal layer includes a first plurality of neurons; and
for the temporal layer, the method further comprising:
receiving, by the at least one processor, a first data sequence of the temporal data sequences at a first time instance;
projecting, by the at least one processor, the projection vector onto the received first data sequence;
determining, by the at least one processor, a projected temporal input based on the projection of the projection vector onto the first input data sequence;
transforming, by the at least one processor, the memory vector based on a matrix multiplication of the reference matrix with the memory vector;
generating, by the at least one processor, an updated memory vector based on an addition of the transformed memory vector with the determined projected temporal input;
performing, by the at least one processor for a corresponding neuron of a group of neurons among the first plurality of neurons, a dot product of the generated memory vector with the one or more temporal kernel coefficients;
determining, by the at least one processor, a corresponding potential value for the corresponding neurons of the group of neurons based on the performed dot product; and
generating, by the at least one processor, an output response based on the determined corresponding potential values.

54. A method, comprising:
in a neural network system that includes an input interface, a memory, and one or more neural processors communicatively coupled with the memory:
receiving sequential data by the input interface;
implementing a non-recurrent neural network in the memory;
training, by the one or more neural processors, the non-recurrent neural network in a convolution mode based on the received sequential data;
determining, by the one or more neural processors, a plurality of temporal kernel coefficients upon the training of the non-recurrent neural network;
configuring, by the one or more neural processors, a recurrent neural network based on the determined plurality of temporal kernel coefficients; and
performing, by the one or more neural processors, inference using the configured recurrent neural network.

55. The method of claim 54, wherein the determined plurality of temporal kernel coefficients corresponds to coefficients that are derived based on a set of basis functions.

56. The method of claim 54, further comprising configuring, by the one or more neural processors, the recurrent neural network based on one or more reference matrices that are defined based on a set of basis functions.
